(19) United States
(12) Patent Application Publication
(10) Pub. No.: US 2013/0114714 A1
(43) Pub. Date: May 9, 2013

(54) IMAGE PROCESSING DEVICE AND IMAGE PROCESSING METHOD

(71) Applicant: Kazushi Sato, Kanagawa (JP)

(72) Inventor: Kazushi Sato, Kanagawa (JP)

(21) Appl. No.: 13/809,692

(22) PCT Filed: Jun. 15, 2011
(86) PCT No.: PCT/JP2011/063661

§ 371 Date: Jan. 11, 2013

(30) Foreign Application Priority Data
Jul. 20, 2010 (JP) 2010-162963

(51) Int. Cl. H04N 7/26

(52) U.S. Cl. CPC H04N 19/00569
USPC 375/240.12

(57) ABSTRACT

Provided is an image processing device including a sorting section for sorting pixel values included in an image such that a pixel value of a first pixel of a first sub-block included in a macro block in the image and a pixel value of a second pixel of a second sub-block included in the macro block are in succession, and a pixel value of a third pixel of the first sub-block and a pixel value of a fourth pixel of the second sub-block are in succession; a first prediction section for generating predicted pixel values for the first pixel and the second pixel using the pixel values sorted by the sorting section; and a second prediction section for generating predicted pixel values for the third pixel and the fourth pixel in parallel with processing of the first prediction section, using the pixel values sorted by the sorting section.

### TECHNICAL FIELD

The present disclosure relates to an image processing device, and an image processing method.

### BACKGROUND ART

Conventionally, a compression technology is widespread that has its object to effectively transmit or accumulate digital images, and that compresses the amount of information of an image by motion compensation and orthogonal transform such as discrete cosine transform, for example, by using redundancy unique to the image. For example, an image encoding device and an image decoding device conforming to a standard technology such as H.26x standards developed by ITU-T or MPEG-y standards developed by MPEG (Moving Picture Experts Group) are widely used in various scenes, such as accumulation and distribution of images by a broadcaster and reception and accumulation of images by a general user.

MPEG2 (ISO/IEC 13818-2) is one of MPEG-y standards defined as a general-purpose image encoding method. MPEG2 is capable of handling both interlaced scanning images and non-interlaced images, and targets high-definition images, in addition to digital images in standard resolution. MPEG2 is currently widely used in a wide range of applications including professional uses and consumer uses. According to MPEG2, for example, by allocating a bit rate of 4 to 8 Mbps to an interlaced scanning image in standard resolution of 720×480 pixels and a bit rate of 18 to 22 Mbps to an interlaced scanning image in high resolution of 1920×1088 pixels, both a high compression ratio and a desirable image quality can be realized.

MPEG2 was primarily for high-quality encoding suitable for broadcasting use, and did not handle a bit rate lower than MPEG1, that is, a high compression ratio. However, with the spread of mobile terminals of recent years, the demand for an encoding method enabling a high compression ratio is increasing. Accordingly, standardization of an MPEG4 encoding method was newly promoted. With regard to an image encoding method which is a part of the MPEG4 encoding method, its standards were accepted as an international standard (ISO/IEC 14496-2) in December 1998.

The H.26x standards (ITU-T Q6/16 VCEG) are standards developed initially with the aim of performing encoding that is suitable for communications such as video telephones and video conferences. The H.26x standards are known to require a large computation amount for encoding and decoding, but to be capable of realizing a higher compression ratio, compared with the MPEG-y standards. Furthermore, with Joint Model of Enhanced-Compression Video Coding, which is a part of the activities of MPEG4, a standard allowing realization of a higher compression ratio by adopting a new function while being based on the H.26x standards is developed. This standard was made an international standard under the names of H.264 and MPEG-4 Part10 (Advanced Video Coding; AVC) in March 2003.

One important technique in the image encoding method describe above is in-screen prediction, that is, intra prediction. Intra prediction is a technique of using a correlation between adjacent blocks in an image and predicting the pixel value of a certain block from the pixel value of another block that is adjacent to thereby reduce the amount of information to be encoded. With an image encoding method before MPEG4, only the DC component and the low frequency component of an orthogonal transform coefficient were the targets of intra prediction, but with H.264/AVC, intra prediction is possible for all the pixel values. By using intra prediction, a significant increase in the compression ratio can be expected for an image where the change in the pixel value is gradual, such as an image of the blue sky, for example.

In H.264/AVC, intra prediction may be performed with a block of 4×4 pixels, 8×8 pixels or 16×16 pixels, for example, as one unit of processing. Also, Non-Patent Literature 1 mentioned below proposes intra prediction that is based on an extended block size, taking a block of 32×32 pixels or 64×64 pixels as a unit of processing.

### CITATION LIST

### Non-Patent Literature

Non-Patent Literature 1: Sung-Chang Lim, Hahyun Lee, Jinho Lee, Jongho Kim, Haechul Choi, Seyoon Jeong, Jin Soo Choi, “Intra coding using extended block size”(VCEG-AL28, July 2009)

### SUMMARY OF INVENTION

### Technical Problem

However, with intra prediction, generally, a prediction process for a certain block has to be completed to start the prediction process for another block that refers to the pixel value of the certain block. Thus, the intra prediction process becomes a bottleneck in conventional image encoding methods, and performing image encoding or decoding at high speed or in real time is difficult.

Accordingly, the technology according to the present disclosure aims to provide an image processing device and an image processing method capable of reducing the processing time required for intra prediction.

### Solution to Problem

According to an embodiment of the present disclosure, there is provided an image processing device including a sorting section for sorting pixel values included in an image such that a pixel value of a first pixel of a first sub-block included in a macro block in the image and a pixel value of a second pixel of a second sub-block included in the macro block are in succession, and a pixel value of a third pixel of the first sub-block and a pixel value of a fourth pixel of the second sub-block are in succession, a first prediction section for generating predicted pixel values for the first pixel and the second pixel using the pixel values sorted by the sorting section, and a second prediction section for generating predicted pixel values for the third pixel and the fourth pixel in parallel with processing of the first prediction section, using the pixel values sorted by the sorting section.

The image processing device may be typically realized as an image encoding device that encodes images.

Further, the sorting section may further sort pixel values of reference pixels included in the image such that a pixel value of a first reference pixel adjacent to the first pixel and a pixel value of a second reference pixel adjacent to the second pixel are in succession, and a pixel value of a third reference pixel adjacent to the third pixel and a pixel value of a fourth reference pixel adjacent to the fourth pixel are in succession.

Further, a pixel position of the first pixel in the first sub-block and a pixel position of the second pixel in the second sub-block may be at a same position, and a pixel position of the third pixel in the first sub-block and a pixel position of the fourth pixel in the second sub-block may be at a same position.

Further, the first pixel, the second pixel, the third pixel and the fourth pixel may be pixels belonging to a same line in the image.

Further, the sorting section may further sort pixel values included in the image such that a pixel value of a fifth pixel of the first sub-block and a pixel value of a sixth pixel of the second sub-block are in succession, and the first prediction section may further generate predicted pixel values for the fifth pixel and the sixth pixel based on the predicted pixel values generated for the first pixel and the second pixel.

Further, the fifth pixel and the sixth pixel may be pixels belonging to a different line from the first pixel and the second pixel in the image.

Further, in a case a pixel on left of a processing target pixel is a pixel to be processed in parallel with the processing target pixel, the first prediction section or the second prediction section may decide an estimated prediction mode for reducing a bit rate of prediction mode information, based on a prediction mode set for a sub-block above a sub-block to which the processing target pixel belongs.

Further, the first prediction section and the second prediction section may perform generation of a predicted pixel value for each pixel in an intra 4×4 prediction mode.

Further, the image processing device may further include an orthogonal transform section for performing orthogonal transform for the first sub-block and orthogonal transform for the second sub-block in parallel.

Further, according to an embodiment of the present disclosure, there is provided an image processing method for processing an image, including sorting pixel values included in an image such that a pixel value of a first pixel of a first sub-block included in a macro block in the image and a pixel value of a second pixel of a second sub-block included in the macro block are in succession, and a pixel value of a third pixel of the first sub-block and a pixel value of a fourth pixel of the second sub-block are in succession, generating predicted pixel values for the first pixel and the second pixel using the sorted pixel values, and generating predicted pixel values for the third pixel and the fourth pixel in parallel with generation of the predicted pixel values for the first pixel and the second pixel, using the sorted pixel values.

Further, according to an embodiment of the present disclosure, there is provided an image processing device including a sorting section for sorting pixel values of reference pixels included in an image such that a pixel value of a first reference pixel adjacent to a first pixel of a first sub-block included in a macro block in the image and a pixel value of a second reference pixel adjacent to a second pixel of a second sub-block included in the macro block are in succession, and a pixel value of a third reference pixel adjacent to a third pixel of the first sub-block and a pixel value of a fourth reference pixel adjacent to a fourth pixel of the second sub-block are in succession, a first prediction section for generating predicted pixel values for the first pixel and the second pixel using the pixel values of the reference pixels sorted by the sorting section, and a second prediction section for generating predicted pixel values for the third pixel and the fourth pixel in parallel with processing of the first prediction section, using the pixel values of the reference pixels sorted by the sorting section.

The image processing device may be typically realized as an image decoding device that decodes images.

Further, a pixel position of the first pixel in the first sub-block and a pixel position of the second pixel in the second sub-block are at a same position, and a pixel position of the third pixel in the first sub-block and a pixel position of the fourth pixel in the second sub-block may be at a same position.

Further, the first pixel, the second pixel, the third pixel and the fourth pixel may be pixels belonging to a same line in the image.

Further, the first prediction section may generate predicted pixel values for a fifth pixel of the first sub-block and a sixth pixel of the second sub-block based on the predicted pixel values generated for the first pixel and the second pixel.

Further, the fifth pixel and the sixth pixel may be pixels belonging to a different line from the first pixel and the second pixel in the image.

Further, in a case a pixel on left of a processing target pixel is a pixel to be processed in parallel with the processing target pixel, the first prediction section or the second prediction section may decide an estimated prediction mode for reducing a bit rate of prediction mode information, based on a prediction mode set for a sub-block above a sub-block to which the processing target pixel belongs.

Further, the first prediction section and the second prediction section may perform generation of a predicted pixel value for each pixel in an intra 4×4 prediction mode.

Further, the image processing device may further include an inverse orthogonal transform section for performing inverse orthogonal transform for the first sub-block and inverse orthogonal transform for the second sub-block in parallel.

Further, according to an embodiment of the present disclosure, there is provided an image processing method for processing an image, including sorting pixel values of reference pixels included in an image such that a pixel value of a first reference pixel adjacent to a first pixel of a first sub-block included in a macro block in the image and a pixel value of a second reference pixel adjacent to a second pixel of a second sub-block included in the macro block are in succession, and a pixel value of a third reference pixel adjacent to a third pixel of the first sub-block and a pixel value of a fourth reference pixel adjacent to a fourth pixel of the second sub-block are in succession, generating predicted pixel values for the first pixel and the second pixel using the sorted pixel values of the reference pixels, and generating predicted pixel values for the third pixel and the fourth pixel in parallel with generation of the predicted pixel values for the first pixel and the second pixel, using the sorted pixel values of the reference pixels.

### Advantageous Effects of Invention

As described above, according to the image processing device and the image processing method of the present disclosure, the processing time required for intra prediction can be reduced,

### BRIEF DESCRIPTION OF DRAWINGS

FIG. 1 is a block diagram showing an example of a configuration of an image encoding device according to an embodiment.

FIG. 2 is a block diagram showing an example of a detailed configuration of an intra prediction section of an image encoding device of an embodiment.

FIG. 3 is a first explanatory diagram for describing an intra 4×4 prediction mode.

FIG. 4 is a second explanatory diagram for describing the intra 4×4 prediction mode.

FIG. 5 is a third explanatory diagram for describing the intra 4×4 prediction mode.

FIG. 6 is an explanatory diagram for describing an intra 8×8 prediction mode.

FIG. 7 is an explanatory diagram for describing an intra 16×16 prediction mode.

FIG. 8 is an explanatory diagram for describing a pixel and a reference pixel in a macro block.

FIG. 9 is an explanatory diagram for describing sorting of encoding target pixel values.

FIG. 10 is an explanatory diagram for describing sorting of reference pixel values.

FIG. 11A is a first explanatory diagram for describing four-fold parallel processing.

FIG. 11B is a second explanatory diagram for describing the four-fold parallel processing.

FIG. 12 is an explanatory diagram for describing parallelization of an orthogonal transform process.

FIG. 13 is an explanatory diagram for describing estimation of a prediction direction.

FIG. 14 is an explanatory diagram for describing reduction in a processing time by the four-fold parallel processing.

FIG. 15A is a first explanatory diagram for describing two-fold parallel processing.

FIG. 15B is a second explanatory diagram for describing the two-fold parallel processing.

FIG. 16A is a first explanatory diagram for describing eight-fold parallel processing.

FIG. 16B is a second explanatory diagram for describing the eight-fold parallel processing.

FIG. 17 is a flow chart showing an example of a flow of an intra prediction process at the time of encoding according to an embodiment.

FIG. 18 is a block diagram showing an example of a configuration of an image decoding device according to an embodiment.

FIG. 19 is a block diagram showing an example of a detailed configuration of an intra prediction section of an image decoding device according to an embodiment.

FIG. 20 is a flow chart showing an example of a flow of an intra prediction process at the time of decoding according to an embodiment.

FIG. 21 is a block diagram showing an example of a schematic configuration of a television.

FIG. 22 is a block diagram showing an example of a schematic configuration of a mobile phone.

FIG. 23 is a block diagram showing an example of a schematic configuration of a recording/reproduction device.

FIG. 24 is a block diagram showing an example of a schematic configuration of an image capturing device.

### DESCRIPTION OF EMBODIMENTS

Hereinafter, preferred embodiments of the present invention will be described in detail with reference to the appended drawings. Note that, in this specification and the drawings, elements that have substantially the same function and structure are denoted with the same reference signs, and repeated explanation is omitted.

Furthermore, the “Description of Embodiments” will he described in the order mentioned below.

1. Example Configuration of Image Encoding Device According to an Embodiment

2. Flow of Process at the Time of Encoding According to an Embodiment

3. Example Configuration of image Decoding Device According to an Embodiment

4. Flow of Process at the Time of Decoding According to an Embodiment

5. Example Application

6. Summary

### <1. Example Configuration of Image Encoding Device According to an Embodiment>

### [1-1. Example of Overall Configuration]

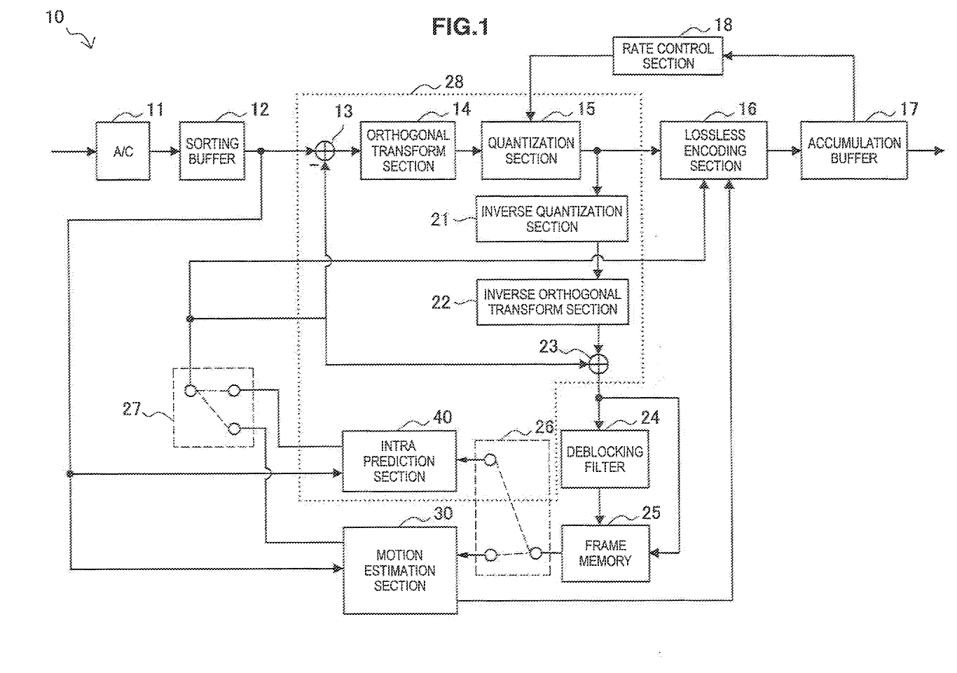

FIG. 1 is a block diagram showing an example of a configuration of an image encoding device 10 according to an embodiment. Referring to FIG. 1, the image encoding device 10 includes an A/D (Analogue to Digital) conversion section 11, a sorting buffer 12, a subtraction section 13, an orthogonal transform section 14, a quantization section 15, a lossless encoding section 16, an accumulation buffer 17, a rate control section 18, an inverse quantization section 21, an inverse orthogonal transform section 22, an addition section 23, a deblocking filter 24, a frame memory 25, selectors 26 and 27, a motion estimation section 30 and an intra prediction section 40.

The A/D conversion section 11 converts an image signal input in an analogue format into image data in a digital format, and outputs a series of digital image data to the sorting buffer 12.

The sorting buffer 12 sorts the images included in the series of image data input from the A/D conversion section 11. After sorting the images according to the a GOP (Group of Pictures) structure according to the encoding process, the sorting buffer 12 outputs the image data which has been sorted to the subtraction section 13, the motion estimation section 30 and the intra prediction section 40.

The image data input from the sorting buffer 12 and predicted image data input by the motion estimation section 30 or the intra prediction section 40 described later are supplied to the subtraction section 13. The subtraction section 13 calculates predicted error data which is a difference between the image data input from the sorting buffer 12 and the predicted image data and outputs the calculated predicted error data to the orthogonal transform section 14.

The orthogonal transform section 14 performs orthogonal transform on the predicted error data input from the subtraction section 13. The orthogonal transform to be performed by the orthogonal transform section 14 may be discrete cosine transform (DCT) or Karhunen-Loeve transform, for example. The orthogonal transform section 14 outputs transform coefficient data acquired by the orthogonal transform process to the quantization section 15.

The transform coefficient data input from the orthogonal transform section 14 and a rate control signal from the rate control section 18 described later are supplied to the quantization section 15. The quantization section 15 quantizes the transform coefficient data, and outputs the transform coefficient data which has been quantized (hereinafter, referred to as quantized data) to the lossless encoding section 16 and the inverse quantization section 21. Also, the quantization section 15 switches a quantization parameter (a quantization scale) based on the rate control signal from the rate control section 18 to thereby change the bit rate of the quantized data to be input to the lossless encoding section 16.

The quantized data input from the quantization section 15 and information about inter prediction or intra prediction input from the motion estimation section 30 or the intra prediction section 40 described later are supplied to the lossless encoding section 16. The information about inter prediction may include prediction mode information, motion vector information, reference image information and the like, for example. Also, the information about intra prediction may include prediction mode information indicating the size of a sub-block, which is a unit of processing of intra prediction, and an optimal prediction direction (prediction mode) for each sub-block.

The lossless encoding section 16 generates an encoded stream by performing a lossless encoding process on the quantized data. The lossless encoding by the lossless encoding section 16 may be variable-length coding or arithmetic coding, for example. Furthermore, the lossless encoding section 16 multiplexes the information about inter prediction or the information about intra prediction mentioned above to the header of the encoded stream (for example, a block header, a slice header or the like). Then, the lossless encoding section 16 outputs the generated encoded stream to the accumulation buffer 17.

The accumulation buffer 17 temporarily stores the encoded stream input from the lossless encoding section 16 using a storage medium, such as a semiconductor memory. Then, the accumulation buffer 17 outputs the accumulated encoded stream at a rate according to the band of a transmission line (or an output line from the image encoding device 10).

The rate control section 18 monitors the free space of the accumulation buffer 17. Then, the rate control section 18 generates a rate control signal according to the free space on the accumulation buffer 17, and outputs the generated rate control signal to the quantization section 15. For example, when there is not much free space on the accumulation buffer 17, the rate control section 18 generates a rate control signal for lowering the bit rate of the quantized data. Also, for example, when the free space on the accumulation buffer 17 is sufficiently large, the rate control section 18 generates a rate control signal for increasing the bit rate of the quantized data.

The inverse quantization section 21 performs an inverse quantization process on the quantized data input from the quantization section 15. Then, the inverse quantization section 21 outputs transform coefficient data acquired by the inverse quantization process to the inverse orthogonal transform section

The inverse orthogonal transform section 22 performs an inverse orthogonal transform process on the transform coefficient data input from the inverse quantization section 21 to thereby restore the predicted error data. Then, the inverse orthogonal transform section 22 outputs the restored predicted error data to the addition section 23.

The addition section 23 adds the restored predicted error data input from the inverse orthogonal transform section 22 and the predicted image data input from the motion estimation section 30 or the intra prediction section 40 to thereby generate decoded image data. Then, the addition section 23 outputs the generated decoded image data to the deblocking filter 24 and the frame memory 25.

The deblocking filter 24 performs a filtering process for reducing block distortion occurring at the time of encoding of an image. The deblocking filter 24 filters the decoded image data input from the addition section 23 to remove the block distortion, and outputs the decoded image data after filtering to the frame memory 25.

The frame memory 25 stores, using a storage medium, the decoded image data input from the addition section 23 and the decoded image data after filtering input from the deblocking filter 24.

The selector 26 reads the decoded image data after filtering which is to be used for inter prediction from the frame memory 25, and supplies the decoded image data which has been read to the motion estimation section 30 as reference image data. Also, the selector 26 reads the decoded image data before filtering which is to be used for intra prediction from the frame memory 25, and supplies the decoded image data which has been read to the intra prediction section 40 as reference image data.

In the inter prediction mode, the selector 27 outputs predicted image data which is a result of inter prediction output from the motion estimation section 30 to the subtraction section 13, and also, outputs the information about inter prediction to the lossless encoding section 16. Furthermore, in the intra prediction mode, the selector 27 outputs predicted image data which is a result of intra prediction output from the intra prediction section 40 to the subtraction section 13, and also, outputs the information about intra prediction to the lossless encoding section 16.

The motion estimation section 30 performs an inter prediction process (inter-frame prediction process) defined by H.264/AVC, based on encoding target image data input from the sorting buffer 12 and the decoded image data supplied via the selector 26. For example, the motion estimation section 30 evaluates a prediction result of each prediction mode using a predetermined cost function. Then, the motion estimation section 30 selects a prediction mode by which a cost function value is the smallest, that is, a prediction mode by which the compression ratio is the highest, as the optimal prediction mode. Also, the motion estimation section 30 generates predicted image data according to the optimal prediction mode. Then, the motion estimation section 30 outputs, to the selector 27, the information about inter prediction including the prediction mode information indicating the selected optimal prediction mode, and the predicted image data.

The intra prediction section 40 performs an intra prediction process for each macro block set in an image based on the encoding target image data input from the sorting buffer 12 and the decoded image data as reference image data supplied from the frame memory 25. In the present embodiment, the intra prediction process of the intra prediction section 40 is parallelized by a plurality of processing branches. Parallel intra prediction process of the intra prediction section 40 will be described later in detail.

With the parallelization of the intra prediction process of the intra prediction section 40, the processing, related to the intra prediction mode, of the subtraction section 13, the orthogonal transform section 14, the quantization section 15, the inverse quantization section 21, the inverse orthogonal transform section 22 and the addition section 23 described above may also be parallelized. In this case, as shown in FIG. 1, the subtraction section 13, the orthogonal transform section 14, the quantization section 15, the inverse quantization section 21, the inverse orthogonal transform section 22, the addition section 23 and the intra prediction section 40 form a parallel processing segment 28. Also, each section in the parallel processing segment 28 includes a plurality of processing branches. Each section in the parallel processing segment 28 may, while performing parallel processing in the intra prediction mode using a plurality of processing branches, use only one processing branch in the inter prediction mode.

### [1-2. Example Configuration of Intra Prediction Section]

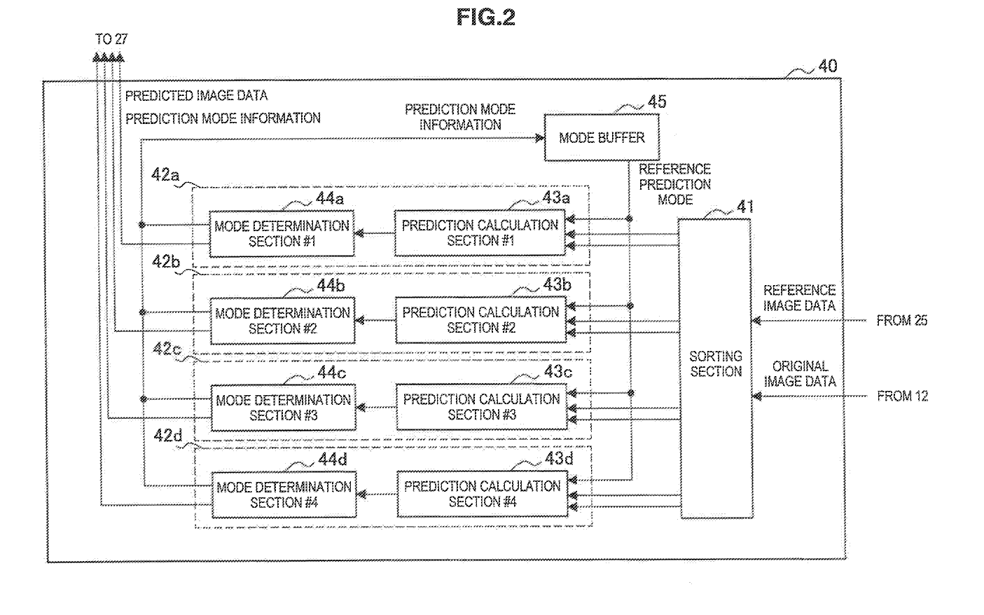

FIG. 2 is a block diagram showing an example of a detailed configuration of the intra prediction section 40 of the image encoding device 10 shown in FIG. 1. Referring to FIG. 2, the intra prediction section 40 includes a sorting section 41, four prediction sections 42a to 42d, and a mode buffer 45. That is, in the example of FIG. 2, the intra prediction section 40 includes four processing branches that are arranged in parallel. However, the number of processing branches of the intra prediction section 40 is not limited to such an example. As will be described later, the intra prediction section 40 may include two or eight processing branches, for example.

The sorting section 41 reads the pixel values included in a macro block in an image (an original image) for each line, for example, and sorts the pixel values according to a predetermined rule. Then, the sorting section 41 outputs a first portion of a series of pixel values after sorting to the first prediction section 42a, a second portion to the second prediction section 42b, a third portion to the third prediction section 42c, and a fourth portion to the fourth prediction section 42d.

Furthermore, the sorting section 41 sorts reference pixel values included in reference image data supplied from the frame memory 25 according to a predetermined rule. The reference image data supplied from the frame memory 25 to the intra prediction section 40 is data of an already encoded portion of an image same as the encoding target image. Then, the sorting section 41 outputs a first portion of a series of reference pixel values after sorting to the first prediction section 42a, a second portion to the second prediction section 42b, a third portion to the third prediction section 42c, and a fourth portion to the fourth prediction section 42d.

Accordingly, in the present embodiment, the sorting section 41 serves as sorting means for sorting pixel values of an original image and reference pixel values. The rule of sorting the pixel values of the sorting section 41 will be described later with examples. Furthermore, the sorting section 41 also serves as inverse multiplexing means for distributing sorted pixel values to respective processing branches.

The prediction sections 42a to 42d generate predicted pixel values for an encoding target macro block using the pixel values of the original image and the reference pixel values which have been sorted by the sorting section 41.

More specifically, the first prediction section 42a includes a first prediction calculation section 43a and a first mode determination section 44a. The first prediction calculation section 43a calculates a plurality of predicted pixel values from the reference pixel values sorted by the sorting section 41, according to a plurality of prediction modes as candidates. A prediction mode mainly identifies the direction from reference pixels used for prediction to encoding target pixels (referred to as a prediction direction). By specifying one prediction mode, a reference pixel to be used for calculation of a predicted pixel value and a calculation formula for the predicted pixel value may be identified for an encoding target pixel. Examples of prediction modes that may be used at the time of intra prediction according to the present embodiment will be described later with reference to examples. The first mode determination section 44a evaluates the candidates of the plurality of prediction modes using a predetermined cost function that is based on the pixel values of the original image sorted by the sorting section 41, the predicted pixel values calculated by the first prediction calculation section 43a, an expected bit rate and the like. Then, the first mode determination section 44a selects a prediction mode by which the cost function value is the smallest, that is, a prediction mode by which the compression ratio is the highest, as the optimal prediction mode. After such a process, the first prediction section 42a outputs prediction mode information indicating the optimal prediction mode selected by the first mode determination section 44a to the mode buffer 45, and also, outputs the prediction mode information and predicted image data including corresponding predicted pixel values to the selector 27.

The second prediction section 42b includes a second prediction calculation section 43b and a second mode determination section 44b. The second prediction calculation section 43b calculates a plurality of predicted pixel values from the reference pixel values sorted by the sorting section 41, according to a plurality of prediction modes as candidates. The second mode determination section 44b evaluates the candidates of the plurality of prediction modes using a predetermined cost function that is based on the pixel values of the original image sorted by the sorting section 41, the predicted pixel values calculated by the second prediction calculation section 43b, an expected bit rate and the like. Then, the second mode determination section 44b selects a prediction mode by which the cost function value is the smallest as the optimal prediction mode. After such a process, the second prediction section 42b outputs prediction mode information indicating the optimal prediction mode selected by the second mode determination section 44b to the mode buffer 45, and also, outputs the prediction mode information and predicted image data including corresponding predicted pixel values to the selector 27.

The third prediction section 42c includes a third prediction calculation section 43c and a third mode determination section 44c. The third prediction calculation section 43c calculates a plurality of predicted pixel values from the reference pixel values sorted by the sorting section 41, according to a plurality of prediction modes as candidates. The third mode determination section 44c evaluates the candidates of the plurality of prediction modes using a predetermined cost function that is based on the pixel values of the original image sorted by the sorting section 41, the predicted pixel values calculated by the third prediction calculation section 43c, an expected bit rate and the like. Then, the third mode determination section 44c selects a prediction mode by which the cost function value is the smallest as the optimal prediction mode. After such a process, the third prediction section 42c outputs prediction mode information indicating the optimal prediction mode selected by the third mode determination section 44c to the mode buffer 45, and also, outputs the prediction mode information and predicted image data including corresponding predicted pixel values to the selector 27.

The fourth prediction section 42d includes a fourth prediction calculation section 43d and a fourth mode determination section 44d. The fourth prediction calculation section 43d calculates a plurality of predicted pixel values from the reference pixel values sorted by the sorting section 41, according to a plurality of prediction modes as candidates. The fourth mode determination section 44d evaluates the candidates of the plurality of prediction modes using a predetermined cost function that is based on the pixel values of the original image sorted by the sorting section 41, the predicted pixel values calculated by the fourth prediction calculation section 43d, an expected bit rate and the like. Then, the fourth mode determination section 44d selects a prediction mode by which the cost function value is the smallest as the optimal prediction mode. After such a process, the fourth prediction section 42d outputs prediction mode information indicating the optimal prediction mode selected by the fourth mode determination section 44d to the mode buffer 45, and also, outputs the prediction mode information and predicted image data including corresponding predicted pixel values to the selector 27.

The mode buffer 45 temporarily stores the prediction mode information input from each of the prediction sections 42a to 42d using a storage medium. The prediction mode information stored by the mode buffer 45 is referred to as a reference prediction mode at the time of estimation of a prediction direction by each of the prediction sections 42a to 42d. Estimation of a prediction direction is a technique of estimating a prediction mode for an encoding target block from a prediction mode set for a reference block by focusing on that the optimal prediction direction (the optimal prediction mode) is the same for adjacent blocks with a high possibility. A prediction mode number of a block for which an appropriate prediction direction can be decided by predicting the prediction direction is not encoded, and the bit rate necessary for encoding may be reduced. Estimation of a prediction direction in the present embodiment will be further described later.

### [1-3. Example of Prediction Mode]

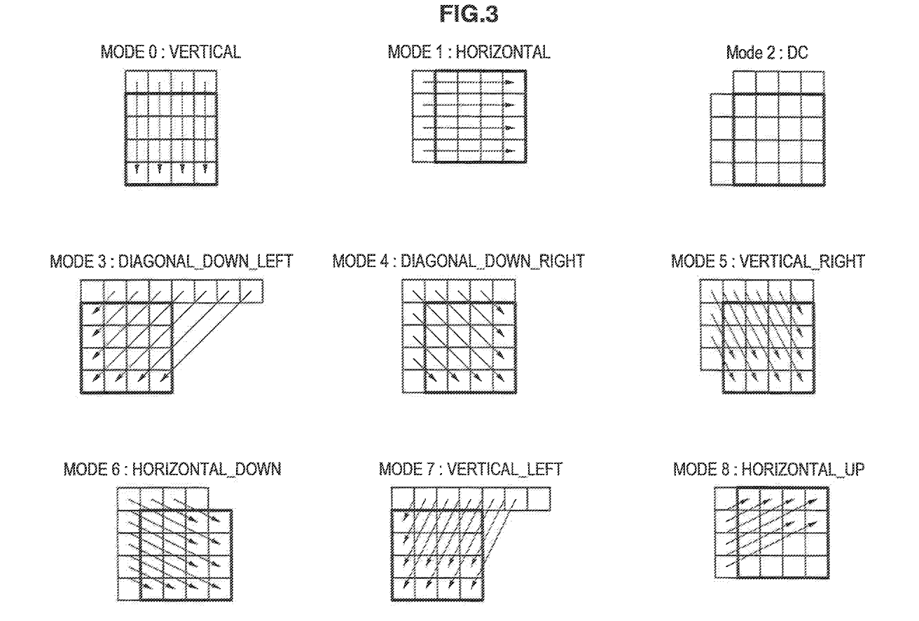

Next, examples of a prediction mode will be given using FIGS. 3 to 7.

### (1) Intra 4×4 Prediction Mode

FIGS. 3 to 5 are explanatory diagrams for describing candidates of a prediction mode in an intra 4×4 prediction mode.

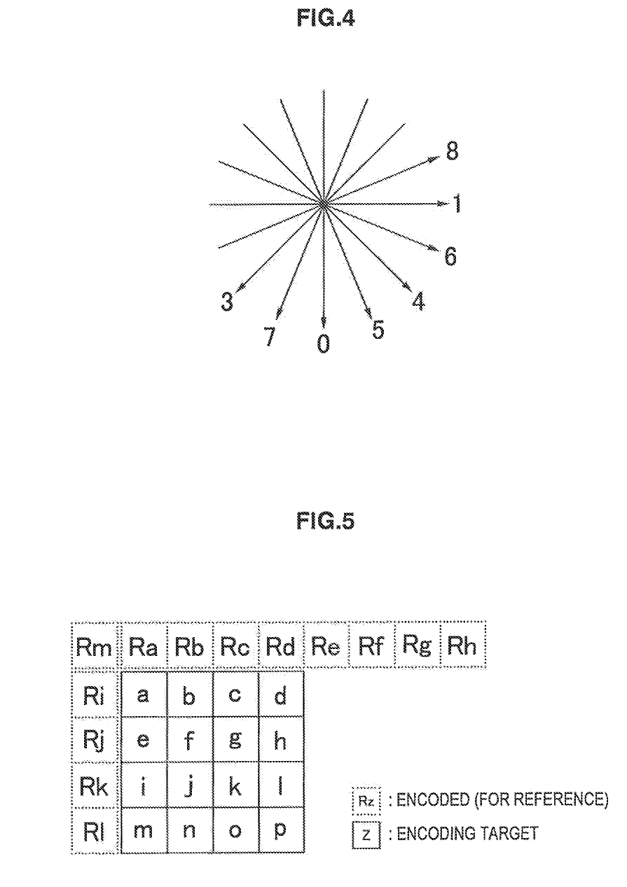

Referring to FIG. 3, nine types of prediction modes (Mode 0 to Mode 8) that may be used in the intra 4×4 prediction mode are shown. Also, in FIG. 4, prediction directions corresponding to respective mode numbers are schematically shown.

In FIG. 5, each of lower case alphabets a to p indicates a pixel value in an encoding target sub-block of 4×4 pixels. The Rz (z=a, b, . . . m) around the encoding target sub-block indicates an already encoded reference pixel value. In the following, calculation of a predicted pixel value in each prediction mode illustrated in FIG. 3 will be described using these encoding target pixel values a to p and reference pixel values Ra to Rm.

### (1-1) Mode 0: Vertical

The prediction direction in Mode 0 is a vertical direction. Mode 0 may be used in a case the reference pixel values Ra, Rb, Rc and Rd are available. Each predicted pixel value is calculated as below:

a=e=i=m=Ra

b=f=j=n=Rb

c=g=k=o=Re

d=h=l=p=Rd

### (1-2) Mode Horizontal

The prediction direction in Mode 1 is horizontal. Mode 1 may be used in a case the reference pixel values Ri, Rj, Rk and Rl are available. Each predicted pixel value is calculated as below:

a=b=c=d=Ri

e=f=g=h=Rj

i=j=k=l=Rk

m=n=o=p=Rl

### (1-3) Mode 2: DC

Mode 2 indicates DC prediction (average value prediction). In a case all of reference pixel values Ra to Rd and Ri to Rl are available, each predicted pixel value is calculated as below:

Each predicted pixel value=(Ra+Rb+Rc+Rd+Ri+Rj+Rk+Rl+4)>>3

In a case none of the reference pixel values Ri to Rl are available, each predicted pixel value is calculated as below:

Each predicted pixel value=(Ra+Rb+Rc+Rd+2)>>2

In a case none of the reference pixel values Ra to Rd are available, each predicted pixel value is calculated as below:

Each predicted pixel value=(Ri+Rj+Rk+Rl+2)>>2

In a case none of the reference pixel values Ra to Rd and Ri to Rl are available, each predicted pixel value is calculated as below:

Each predicted pixel value=128

### (1-4) Mode 3: Diagonal_Down_Left

The prediction direction in Mode 3 is diagonal down left. Mode 3 may be used in a case the reference pixel values Ra to Rh are available. Each predicted pixel value is calculated as below:

a=(Ra+2Rb+Rc+2)>>2

b=e=(Rb+2Rc+Rd+2)>>2

c=f=i=(Rc+2Rd+Re+2)>>2

d=g=j=m=(Rd+2Re+Rf+2)>>2

h=k=n=(Re+2Rf+Rg+2)>>2

l=o=(Rf+2Rg+Rh+2)>>2

p=(Rg+3Rh+2)>>2

(1-5) Mode 4: Diagonal_Down_Right The prediction direction in Mode 4 is diagonal down right. Mode 4 may be used in a case the reference pixel values Ra to Rd and Ri to Rm are available. Each predicted pixel value is calculated as below:

m=(Rj+2Rk+Rl+2)>>2

i=n=(Ri+2Rj+Rk+2)>>2

e=j=o=(Rm+2Ri+Rj+2)>>2

a=f=k=p=(Ra+2Rm+Ri+2)>>2

b=g=l=(Rm+2Ra+Rb+2)>>2

c=h=(Ra+2Rb+Rc+2)>>2

d=(Rb+2Rc+Rd+2)>>2

### (1-6) Mode 5: Vertical_Right

The prediction direction in Mode 5 is vertical right. Mode 5 may he used in a case the reference pixel values Ra to Rd and Ri to Rm are available. Each predicted pixel value is calculated as below:

a=j=(Rm+Ra+1)>>1

b=k=(Ra+Rb+1)>>1

c=l=(Rb+Rc+1)>>1

d=(Rc+Rd+1)>>1

e=n=(Ri+2Rm+Ra+2)>>2

f=o=(Rm+2Ra+Rb+2)>>2

g=p=(Ra+2Rb+Rc+2)>>2

h=(Rb+2Rc+Rd+2)>>2

i=(Rm+2Ri+Rj+2)>>2

m=(Ri+2Rj+Rk+2)>>2

### (1-7) Mode 6: Horizontal_Down

The prediction direction in Mode 6 is horizontal down. Mode 6 may be used in a case the reference pixel values Ra to Rd and Ri to Rm are available. Each predicted pixel value is calculated as below:

a=g=(Rm+Ri+1)>>1

b=h=(Ri+2Rm+Ra+2)>>2

c=(Rm+2Ra+Rb+2)>>2

d=(Ra+2Rb+Rc+2)>>2

e=k=(Ri+Rj+1)>>1

f=l=(Rm+2Ri+Rj+2)>>2

i=o=(Rj+Rk+1)>>1

j=p=(Ri+2Rj+Rk+2)>>2

m=(Rk+Rl+1)>>1

n=(Rj+2Rk+Rl+2)>>2

### (1-8) Mode 7: Vertical_Left

The prediction direction in Mode 7 is vertical left. Mode 7 may be used in a case the reference pixel values Ra to Rg are available. Each predicted pixel value is calculated as below:

a=(Ra+Rb+1)>>1

b=i=(Rb+Rc+1)>>1

c=j=(Rc+Rd+1)>>1

d=k=(Rd+Re+1)>>1

l=(Re+Rf+1)>>1

e=(Ra+2Rb+Rc+2)>>2

f=m=(Rb+2Rc+Rd+2)>>2

g=n=(Rc+2Rd+Re+2)>>2

h=o=(Rd+2Re+Rf+2)>>2

p=(Re+2Rf+Rg+2)>>2

### (1-9) Mode 8: Horizontal_Up

The prediction direction in Mode 8 is horizontal up. Mode 8 may be used in a case the reference pixel values Ri to Rl are available. Each predicted pixel value is calculated as below:

a=(Ri+Rj+1)>>1

b=(Ri+2Rj+Rk+2)>>2

c=e=(Rj+Rk+1)>>1

d=f=(Rj+2Rk+Ri+2)>>2

g=i=(Rk+Rl+1)>>1

h=j=(Rk+3Rl+2)>>2

The calculation formulae of predicted pixel values in the nine types of prediction modes are the same as the calculation formulae of the intra 4×4 prediction mode defined by H.264/AVC. The prediction calculation sections 43a to 43d of the prediction sections 42a to 42d of the intra prediction section 40 described above may calculate predicted pixel values corresponding to respective prediction modes based on the reference pixel values sorted by the sorting section 41 while taking the nine prediction modes as the candidates.

### (2) Intra 8×8 Prediction Mode

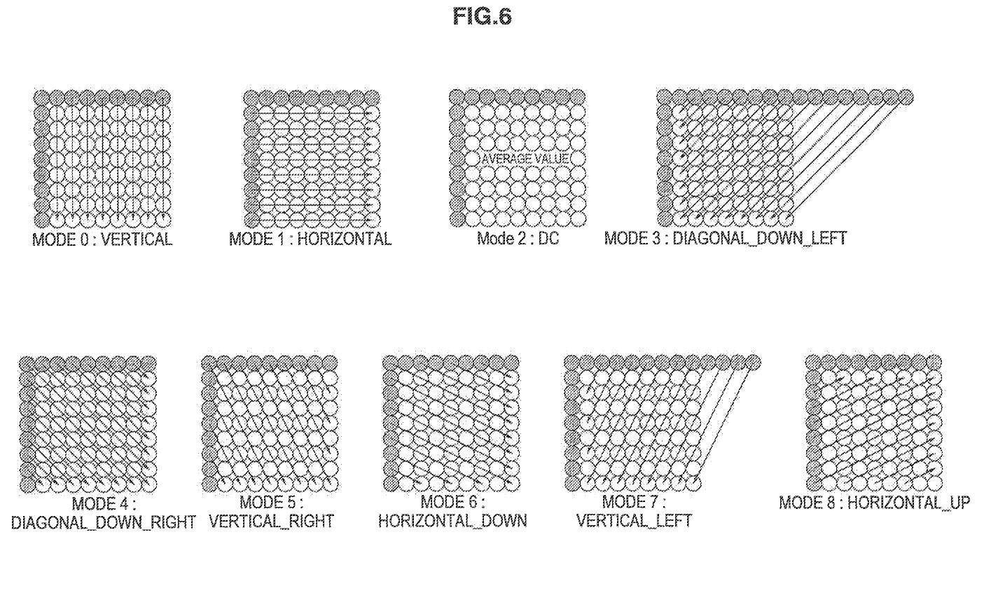

FIG. 6 is an explanatory diagram for describing candidates of a prediction mode in an intra 8×8 prediction mode. Referring to FIG. 6, nine types of prediction modes (Mode 0 to Mode 8) that may be used in the intra 8×8 prediction mode are shown.

The prediction direction in Mode 0 is a vertical direction. The prediction direction in Mode 1 is a horizontal direction. Mode 2 indicates DC prediction (average value prediction). The prediction direction in Mode 3 is diagonal down left. The prediction direction in Mode 4 is diagonal down right. The prediction direction in Mode 5 is vertical right. The prediction direction in Mode 6 is horizontal down. The prediction mode in Mode 7 is vertical left. The prediction direction in Mode 8 is horizontal up.

In the intra 8×8 prediction mode, before calculating the predicted pixel. values, low-pass filtering is performed on the reference pixel values. Then, the predicted pixel values are calculated according to each prediction mode based on the reference pixel values after low-pass filtering. The calculation formulae of predicted pixel values in the nine types of prediction modes of the intra 8×8 prediction mode may also be the same as the calculation formulae defined by H.264/AVC. The prediction calculation sections 43a to 43d of the prediction sections 42a to 42d of the intra prediction section 40 described above may calculate predicted pixel values corresponding to respective prediction modes based on the reference pixel values sorted by the sorting section 41 while taking the nine prediction modes of the intra 8×8 prediction mode as the candidates.

### (3) Intra 16×16 Prediction Mode

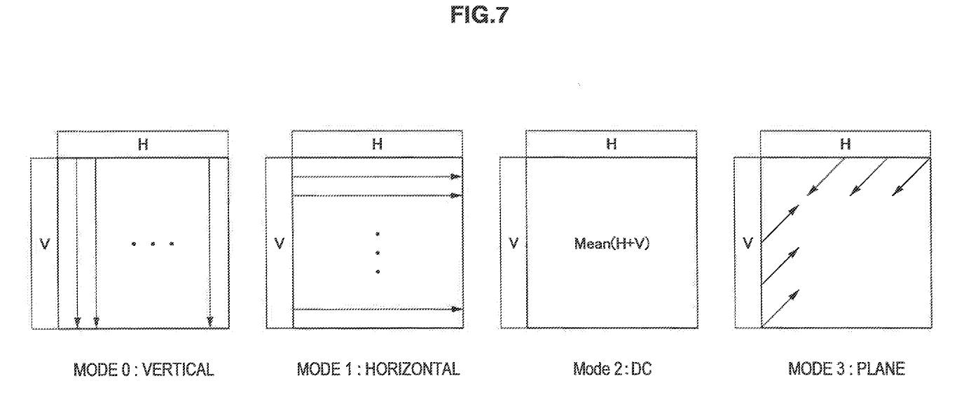

FIG. 7 is an explanatory diagram for describing candidates of a prediction mode in an intra 16×16 prediction mode. Referring to FIG. 7, four types of prediction modes (Mode 0 to Mode 3) that may be used in the intra 16×16 prediction mode are shown.

The prediction direction in Mode 0 is a vertical direction. The prediction direction in Mode 1 is a horizontal direction, Mode 2 indicates DC prediction (average value prediction). Mode 3 indicates plane direction. The calculation formulae of predicted pixel values in the four types of prediction modes of the intra 16×16 prediction mode may also be the same as the calculation formulae defined by H.264/AVC, The prediction calculation sections 43a to 43d of the prediction sections 42a to 42d of the intra prediction section 40 described above may calculate predicted pixel values corresponding to respective prediction modes based on the reference pixel values sorted by the sorting section 41 while taking the four prediction modes of the intra 16×16 prediction mode as the candidates.

### (4) Intra Prediction of Chroma Signal

A prediction mode for a chroma signal may be set independently of a prediction mode for a luma signal. The prediction mode for a chroma signal may include four types of prediction modes, as in the intra 16×16 prediction mode for a luma signal described above. In H.264/AVC, Mode 0 of the prediction mode for a chroma signal is DC prediction, Mode 1 is horizontal prediction, Mode 2 is vertical prediction, and Moe 4 is plane prediction.

### [1-4. Explanation on Parallel Processing]

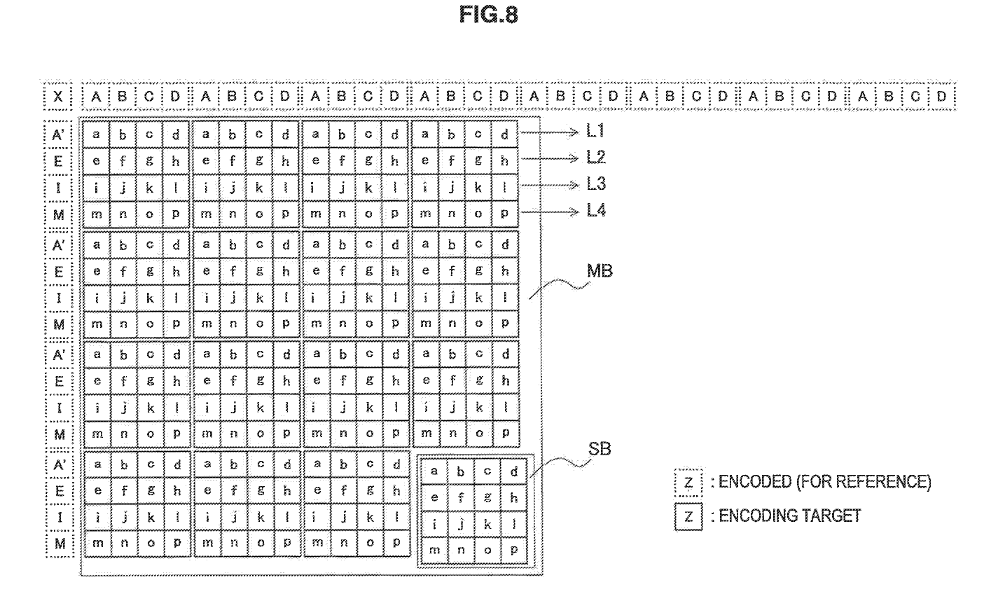

Next, parallel intra prediction processes of the intra prediction section 40 shown in FIG. 2 will be described in detail using FIGS. 8 to 16B.

### (1) Sorting Process

FIG. 8 shows encoding target pixels in a macro block before sorting by the sorting section 41 of the intra prediction section 40, and reference pixels around the macro block.

Referring to FIG. 8, a macro block MB of 16×16 pixels includes sixteen sub-blocks SB of 4×4 pixels. One sub-block SB includes sixteen pixels represented respectively by lower case alphabets a to p. A first line L1 of the macro block MB includes four sub-blocks with a total of sixteen pixels a's, b's, c's and d's. The order of the pixels of the first line L1 is a, b, c, d, a, b, c, d, . . . . A second line L2 of the macro block MB includes four sub-blocks with a total of sixteen pixels e's, f's, g's and h's. The order of the pixels of the second line L2 is e, f, g, h, e, f, g, h, . . . . A third line L3 of the macro block MB includes four sub-blocks with a total of sixteen pixels i's, j's, k's and l's. The order of the pixels of the third line L3 is i, j, k, l, i, j, k, l, . . . . A fourth line L4 of the macro block MB includes four sub-blocks with a total of sixteen pixels m's, n's, o's and p's. The order of the fourth line L4 is m, n, o, p, m, n, o, p.

Reference pixels represented respectively by upper case alphabets A to D, A′, E, I, M and X are shown around the macro block MB. The order of the reference pixels above the first line L1 of the macro block MB is A, B, C, D, A, B, C, D, . . . .

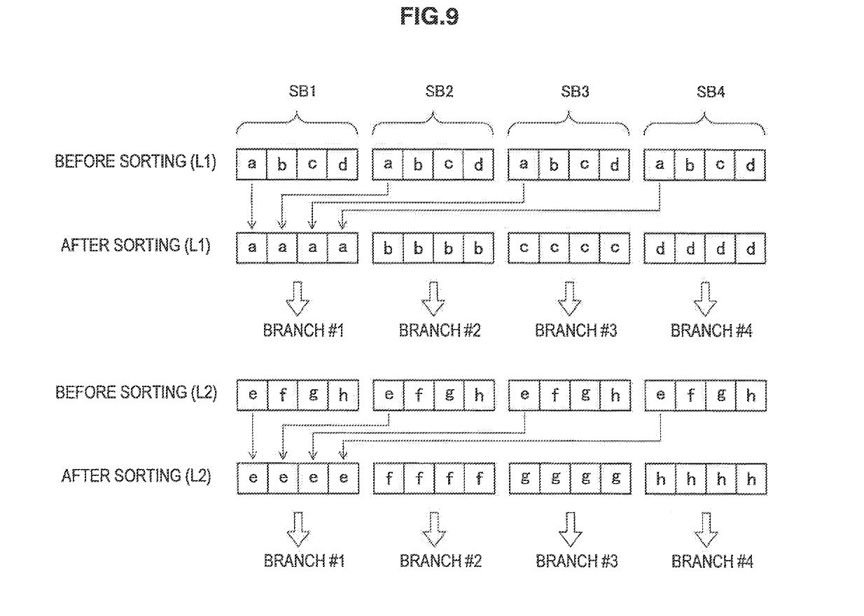

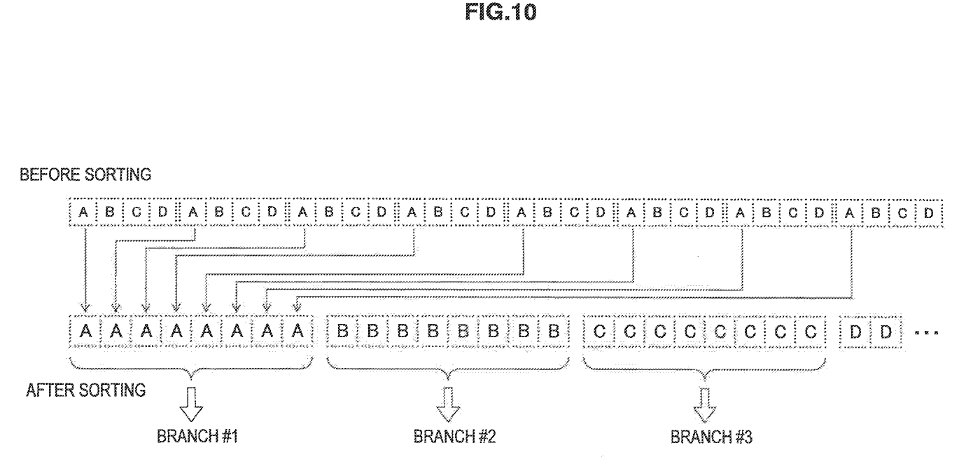

FIG. 9 is an explanatory diagram for describing sorting of the encoding target pixels shown in FIG. 8 by the sorting section 41.

The rule of sorting of the pixel values by the sorting section 41 is a rule as follows, for example. That is, the sorting section 41 causes the pixel value of a first pixel of a sub-block SB1 and the pixel value of a second pixel of a sub-block SB2 that are included in the macro block MB to be in succession. The pixel positions of the first pixel and the second pixel in the sub-blocks may be the same position. For example, the first pixel is a pixel a of the sub-block SB1, and the second pixel is a pixel a of the sub-block SB2. In the case of four-fold parallel, the sorting section 41 further causes the pixel value of a pixel a of a sub-block SB3 and the pixel value of a pixel a of a sub-block SB4 to be in succession to the pixel values of the first pixel and the second pixel. The sorting section 41 successively outputs the pixel values of the pixels a of the sub-blocks SB1 to SB4 to the first prediction section 42a (branch #1 in FIG. 9).

Likewise, the sorting section 41 causes the pixel value of a third pixel of the sub-block SB1 and the pixel value of a fourth pixel of the sub-block SB2 included in the macro block MB to be in succession. The pixel positions of the third pixel and the fourth pixel in the sub-blocks may be the same position. For example, the third pixel is a pixel b of the sub-block SB1, and the fourth pixel is a pixel b of the sub-block SB2. In the case of four-fold parallel, the sorting section 41 further causes the pixel value of a pixel b of the third sub-block SB3 and the pixel value of a pixel b of the sub-block SB4 to be in succession to the pixel values of the third pixel and the fourth pixel. The sorting section 41 successively outputs the pixel values of the pixels b of the sub-blocks SB1 to SB4 to the second prediction section 42b (branch #2 in FIG. 9).

Likewise, the sorting section 41 successively outputs the pixel values of pixels c of the sub-blocks SB1 to SB4 to the third prediction section 42c (branch #3 in FIG. 9). Furthermore, the sorting section 41 successively outputs the pixel values of pixels d of the sub-block SB1 to SB4 to the fourth prediction section 42d (branch #4 in FIG. 9).

Additionally, as shown in FIG. 9, the first pixel, the second pixel, the third pixel and the fourth pixel are desirably pixels belonging to the same line in an image. This allows to prevent the increase in the memory resources required for the sorting process, because the sorting section 41 has to hold the pixel values of only one line at the time of the sorting process.

The sorting process by the sorting section 41 is performed in the same manner on the second line L2 of the macro block MB. That is, the sorting section 41 successively outputs the pixel values of pixels e of the sub-blocks SB1 to SB4 to the first prediction section 42a. Also, the sorting section 41 successively outputs the pixel values of pixels f of the sub-blocks SB1 to SB4 to the second prediction section 42b. Furthermore, the sorting section 41 successively outputs the pixel values of pixels g of the sub-blocks SB1 to SB4 to the third prediction section 42c. Furthermore, the sorting section 41 successively outputs the pixel values of pixels h of the sub-blocks SB1 to SB4 to the fourth prediction section 42d.

FIG. 10 is an explanatory diagram for describing sorting of the reference pixels shown in FIG. 8 by the sorting section 41.

The sorting section 41 sorts the reference pixel values such that the pixel value of a first reference pixel adjacent to the first pixel and the pixel value of a second reference pixel adjacent to the second pixel are in succession, and the pixel value of a third reference pixel adjacent to the third pixel and the pixel value of a fourth reference pixel adjacent to the fourth pixel are in succession.

As described above, the first pixel is the pixel a of the sub-block SB1, for example. The second pixel is the pixel a of the sub-block SB2. In the example of FIG. 10, the pixel values of reference pixels A above the pixels a of the sub-blocks SB1 to SB4 are in succession after the sorting by the sorting section 41. The sorting section 41 successively outputs these reference pixel values to, for example, the first prediction section 42a (branch #1 in FIG. 10).

Likewise, the third pixel is the pixel b of the sub-block SB1. The fourth pixel is the pixel b of the sub-block SB2. In the example of FIG. 10, the pixel values of reference pixels B above the pixels b of the sub-blocks SB1 to SB4 are in succession after the sorting by the sorting section 41. The sorting section 41 successively outputs these reference pixel values to, for example, the second prediction section 42b (branch #2 in FIG. 10).

Also, the sorting section 41 successively outputs the pixel values of reference pixels C above the pixels c of the sub-blocks SB1 to SB4 to, for example, the third prediction section 42c (branch #3 in FIG. 10). Furthermore, the sorting section 41 successively outputs the pixel values of reference pixels D above the pixels d of the sub-blocks SB1 to SB4 to, for example, the fourth prediction section 42d (branch #4 in FIG. 10).

Additionally, the sorting section 41 outputs the pixel values of the reference pixels A′, E, I and M on the left of the macro block MB to the first prediction section 42a, the second prediction section 42b, the third prediction section 42c and the fourth prediction section 42d without sorting them.

### (2) Four-Fold Parallel Prediction Processing

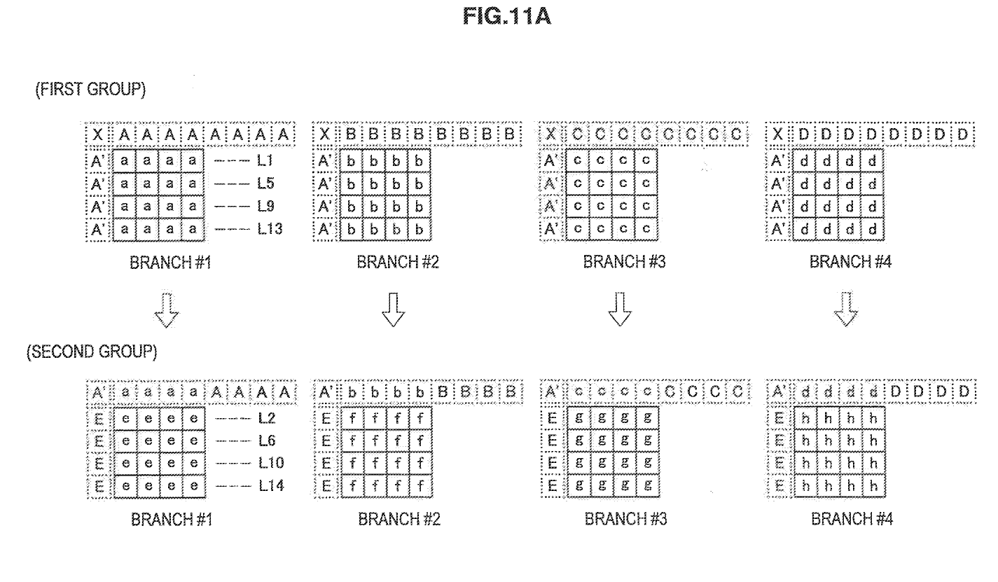

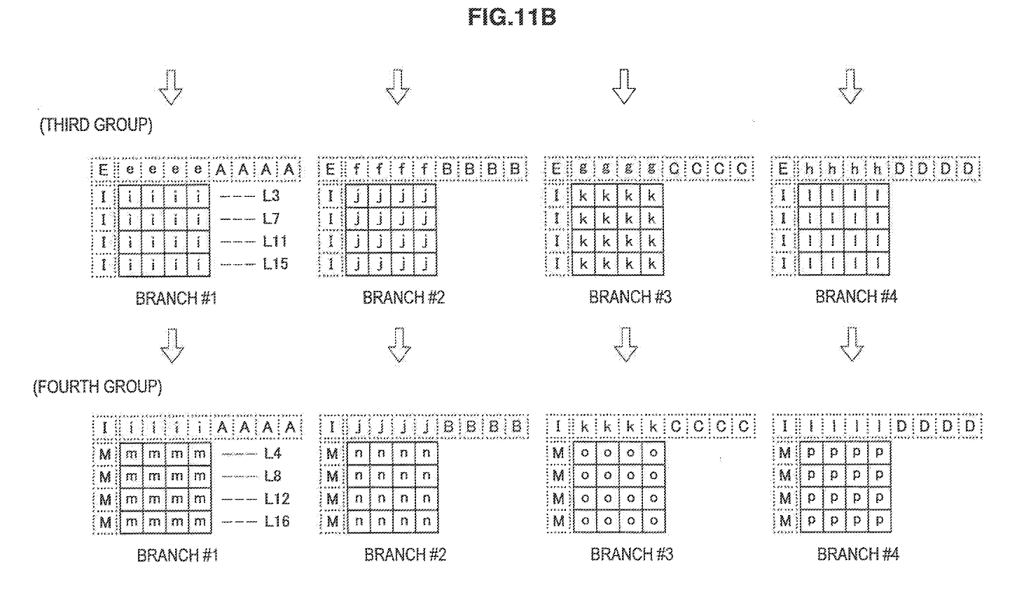

FIGS. 11A and 11B are explanatory diagrams for describing four-fold parallel processing of the prediction sections 42a to 42d of the intra prediction section 40. Referring to FIGS. 11A and 11B, generation processing of a predicted pixel value for a pixel in the macro block MB shown in FIG. 8 is grouped into first, second, third and fourth groups.

The first group includes generation of a predicted pixel value for a pixel a by the first prediction section 42a, generation of a predicted pixel value for a pixel b by the second prediction section 42b, generation of a predicted pixel value for a pixel c by the third prediction section 42c, and generation of a predicted pixel value for a pixel d by the fourth prediction section 42d. Generation of the predicted pixel values for the four pixels is performed in parallel for each line. The first prediction section 42a uses pixels A as the reference pixels above and on the top right, a pixel X as the reference pixel on the top left, and pixels A′ as the reference pixels on the left. The second prediction section 42b uses pixels B as the reference pixels above and on the top right, a pixel X as the reference pixel on the top left, and pixels A′ as the reference pixels on the left. The third prediction section 42c uses pixels C as the reference pixels above and on the top right, a pixel X as the reference pixel on the top left, and pixels A′ as the reference pixels on the left. The fourth prediction section 42d uses pixels D as the reference pixels above and on the top right, a pixel X as the reference pixel on the top left, and pixels A′ as the reference pixels on the left.

The second group includes generation of a predicted pixel value for a pixel e by the first prediction section 42a, generation of a predicted pixel value for a pixel f by the second prediction section 42b, generation of a predicted pixel value for a pixel g by the third prediction section 42c, and generation of a predicted pixel value for a pixel h by the fourth prediction section 42d. Generation of the predicted pixel values for the four pixels is performed in parallel for each line. The first prediction section 42a uses pixels a as the reference pixels above, pixels A as the reference pixels on the top right, a pixel A′ as the reference pixel on the top left, and pixels E as the reference pixels on the left. The second prediction section 42b uses pixels b as the reference pixels above, pixels B as the reference pixels on the top right, a pixel A′ as the reference pixel on the top left, and pixels E as the reference pixels on the left. The third prediction section 42c uses pixels c as the reference pixels above, pixels C as the reference pixels on the top right, a pixel A′ as the reference pixel on the top left, and pixels E as the reference pixels on the left. The fourth prediction section 42d uses pixels d as the reference pixels above, pixels D as the reference pixels on the top right, a pixel A′ as the reference pixel on the top left, and pixels E as the reference pixels on the left.

The third group includes generation of a predicted pixel value for a pixel i by the first prediction section 42a, generation of a predicted pixel value for a pixel j by the second prediction section 42b, generation of a predicted pixel value for a pixel k by the third prediction section 42c, and generation of a predicted pixel value for a pixel I by the fourth prediction section 42d. Generation of the predicted pixel values for the four pixels is performed in parallel for each line. The first prediction section 42a uses pixels e as the reference pixels above, pixels A as the reference pixels on the top right, a pixel E as the reference pixel on the top left, and pixels I as the reference pixels on the left. The second prediction section 42b uses pixels f as the reference pixels above, pixels B as the reference pixels on the top right, a pixel E as the reference pixel on the top left, and pixels I as the reference pixels on the left. The third prediction section 42c uses pixels g as the reference pixels above, pixels C as the reference pixels on the top right, a pixel B as the reference pixel on the top left, and pixels I as the reference pixels on the left. The fourth prediction section 42d uses pixels h as the reference pixels above, pixels D as the reference pixels on the top right, a pixel E as the reference pixel on the top left, and pixels I as the reference pixels on the left.

The fourth group includes generation of a predicted pixel value for a pixel m by the first prediction section 42a, generation of a predicted pixel value for a pixel n by the second prediction section 42b, generation of a predicted pixel value for a pixel o by the third prediction section 42c, and generation of a predicted pixel value for a pixel p by the fourth prediction section 42d. Generation of the predicted pixel values for the four pixels is performed in parallel for each line. The first prediction section 42a uses pixels i as the reference pixels above, pixels A as the reference pixels on the top right, a pixel I as the reference pixel on the top left, and pixels M as the reference pixels on the left The second prediction section 42b uses pixels j as the reference pixels above, pixels B as the reference pixels on the top right, a pixel I as the reference pixel on the top left, and pixels M as the reference pixels on the left. The third prediction section 42c uses pixels k as the reference pixels above, pixels C as the reference pixels on the top right, a pixel I as the reference pixel on the top left, and pixels M as the reference pixels on the left. The fourth prediction section 42d uses pixels I as the reference pixels above, pixels D as the reference pixels on the top right, a pixel I as the reference pixel on the top left, and pixels M as the reference pixels on the left.

With such fourfold parallel processing by the first prediction section 42a, the second prediction section 42b, the third prediction section 42c and the fourth prediction section 42d, the intra prediction section 40 can perform the intra prediction process for the four sub-blocks as the targets in parallel without having to wait for the completion of the intra prediction process for each sub-block.

Here, an example of performing mainly the intra prediction process in the intra 4×4 prediction mode by the intra prediction section 40 in four-fold parallel is described. Additionally, the intra prediction section 40 may perform the intra prediction process in the intra 8×8 prediction mode or the intra 16×16 prediction mode described above. For example, in the case the size of a macro block is 16×16 pixels, the intra prediction process in the intra 8×8 prediction mode can be performed in two-fold parallel. Also, for example, in the case the size of a macro block is 32×32 pixels, the intra prediction process in the intra 8×8 prediction mode can be performed in four-fold parallel, and the intra prediction process in the intra 16×16 prediction mode can be performed in two-fold parallel. The intra prediction section 40 may perform the intra prediction process in all the usable prediction modes of the three types of sub-block sizes, and may select one optimal sub-block size and one optimal prediction mode for each sub-block.

Furthermore, the intra prediction section 40 may perform the intra prediction process in parallel only in the intra 4×4 prediction mode. In the present embodiment, as a result of sorting the pixel values, the distance from an encoding target pixel to a reference pixel becomes greater and the correlation between the pixels less as the size of a sub-block, which is a unit of processing of intra prediction, increases. Thus, in many cases, a prediction result closer to the original image is likely to be obtained when the intra prediction is performed in the intra 4×4 prediction mode where the unit of processing of intra prediction is smaller.

### (3) Parallelization of Orthogonal Transform Process

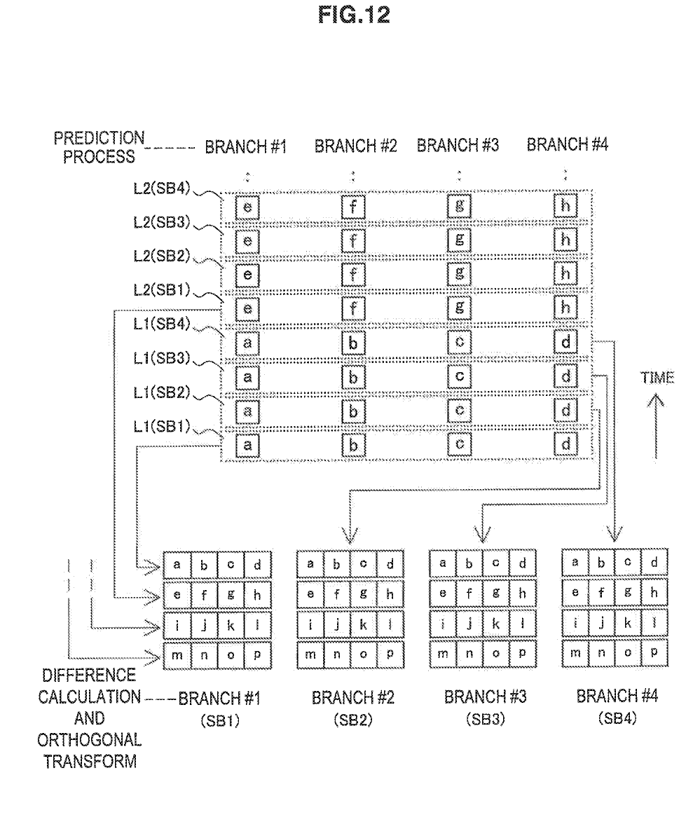

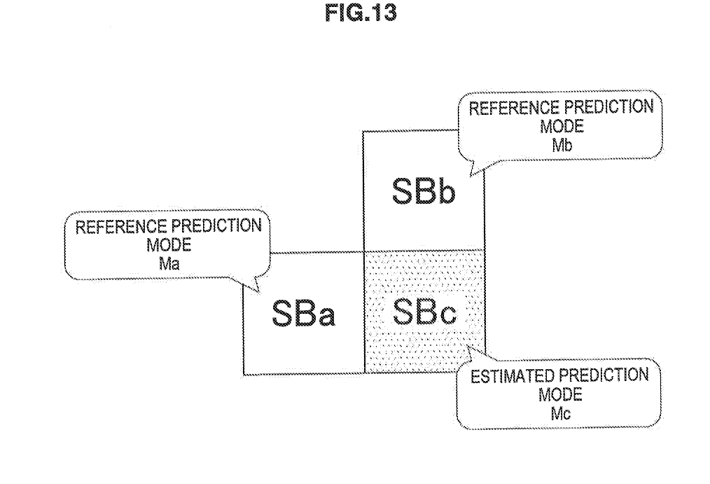

In the intra prediction mode, it is desirable that the process of each section included in the parallel processing segment 28 of the image encoding device 10 shown in FIG. 1 is parallelized together with the parallelization of the intra prediction process described above. FIG. 12 is an explanatory diagram for describing the parallelization of orthogonal transform by the orthogonal transform section 14.

Pixel values to be output in parallel from the intra prediction section 40 are shown in the upper part of FIG. 12. With respect to the order of output, the pixel values are output from the bottom to the top in the drawing. For example, the predicted pixel values for the pixels a of the sub-blocks SB1, SB2, SB3 and SB4, and for the pixels e for the sub-blocks SB1, SB2, SB3 and SB4 are output in this order from the first prediction section 42a. The predicted pixel values for the pixels b of the sub-blocks SB1, SB2, SB3 and SB4, and for the pixels f of the sub-blocks SB1, SB2, SB3 and SB4 are output in this order from the second prediction section 42b. The predicted pixel values for the pixels c of the sub-blocks SB1, SB2, SB3 and SB4, and for the pixels g of the sub-blocks SB1, SB2, SB3 and SB4 are output in this order from the third prediction section 42c. The predicted pixel values for the pixels d of the sub-blocks SB1, SB2, SB3 and SB4, and for the pixels h of the sub-blocks SB1, SB2, SB3 and SB4 are output in this order from the fourth prediction section 42d.

Pixel values (difference pixel values) to be input in parallel to the orthogonal transform section 14 are shown in the lower part of FIG. 12. The orthogonal transform section 14 includes four processing branches, and sixteen pixels from the pixel a to the pixel p of the sub-block SB1 are input to a first processing branch. Sixteen pixels from the pixel a to the pixel p of the sub-block SB2 are input to a second processing branch. Sixteen pixels from the pixel a to the pixel p of the sub-block SB3 are input to a third processing branch. Sixteen pixels from the pixel a to the pixel p of the sub-block SB4 are input to a fourth processing branch. Then, the orthogonal transform section 14 performs the orthogonal transform process for the four sub-blocks SB1 to SB4 in parallel.

Likewise, the subtraction section 13, the quantization section 15, the inverse quantization section 21, the inverse orthogonal transform section 22 and the addition section 23 also perform their respective processes in four-fold parallel in the intra prediction mode.

### (4) Estimation of Prediction Direction

The first prediction section 42a, the second prediction section 42b, the third prediction section 42c and the fourth prediction section 42d of the intra prediction section 40 may estimate the optimal prediction mode (prediction direction) of an encoding target block from the prediction mode (prediction direction) set for a block to which a reference pixel belongs, to suppress the increase in the bit rate due to the encoding of the prediction mode information. In this case, if a prediction mode that is estimated (hereinafter, referred to as an estimated prediction mode) and an optimal prediction mode selected using a cost function value are the same, only the information indicating that the prediction mode can be estimated may be encoded as the prediction mode information. The information indicating that the prediction mode can be estimated corresponds to “MostProbableMode” in H.264/AVC, for example.

FIG. 13 is an explanatory diagram for describing estimation of a prediction direction. Referring to FIG. 13, an encoding target sub-block SBc, a reference block SBa on the left of the sub-block SBc and a reference block SBb above the sub-block SBc are shown. The reference prediction mode set for the reference block SBa is Ma, and the reference prediction mode set for the reference block SBb is Mb. Also, the estimated prediction mode for the encoding target sub-block SBc is Mc.

In H.264/AVC, the estimated prediction mode Mc is decided by the following formula:

Mc=min(Ma, Mb)

That is, one with the smaller prediction mode number, of the reference prediction modes Ma and Mb, will be the estimated prediction mode for the encoding target sub-block.

The first prediction section 42a of the intra prediction section 40 according to the present embodiment may estimate the prediction mode in the same manner as in H.264/AVC, because the sub-block on the left is already encoded at the time of performing the intra prediction process:

Mc=min.(Ma, Mb)

On the other hand, the second prediction section 42b, the third prediction section 42c and the fourth prediction section 42d estimate the prediction mode by, for example, the following formula, because the sub-block on the left is not yet encoded at the time of performing the intra prediction process due to parallelization of the intra prediction process:

Mc=Mb

By estimating the prediction mode (the prediction direction) in this manner, the increase in the bit rate due to encoding of the prediction mode information can be suppressed even in the case of performing the intra prediction processes in parallel.

### (5) Reduction in Processing Time

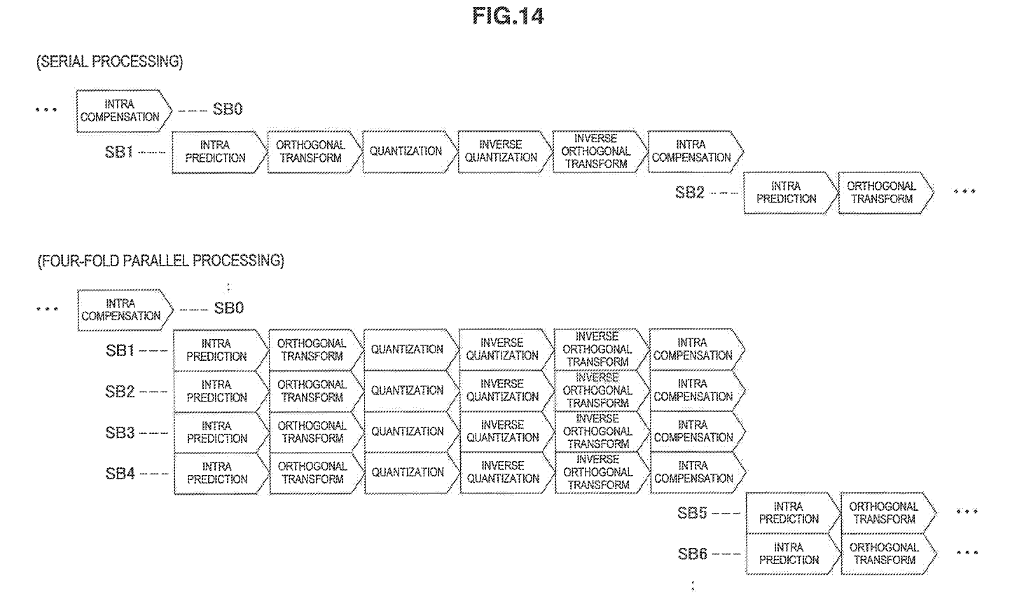

FIG. 14 is an explanatory diagram for describing reduction in a processing time by four-fold parallel processing. A flow of serial image encoding processing where the parallel processing of the present embodiment is not implemented is schematically shown in the upper part of FIG. 14. In the serial image encoding processing, for example, intra prediction for the sub-block SB1 adjacent to a sub-block SB0 is started after generation of a reference pixel value for the sub-block SB0 is completed. Then, orthogonal transform, quantization, inverse quantization, inverse quantization, inverse orthogonal transform and intra compensation (addition of a difference pixel value and a predicted pixel value) for the sub-block SB1 are serially performed, and a reference pixel value for the sub-block SB1 is generated. Also, after the generation of a reference pixel value for the sub-block SB1 is completed, intra prediction for the sub-block SB2 adjacent to the sub-block SB1 is started. Then, the processes such as the orthogonal transform for the sub-block SB2 are serially performed.

In contrast, with the four-fold processing according to the present embodiment, after the generation of a reference pixel value for the sub-block SB0 is completed, intra prediction is started for the four sub-blocks SB1, SB2, SB3 and SB4 in parallel, for example. Then, orthogonal transform, quantization, inverse quantization, inverse quantization, inverse orthogonal transform and intra compensation for the sub-blocks SB1, SB2, SB3 and SB4 are performed in parallel, and reference pixel values for the sub-blocks SB1, SB2, SB3 and SB4 are generated. Then, subsequently, intra prediction for sub-blocks SB5, SB6 and the like are started in parallel. With such four-fold parallel processing, a bottleneck in the intra prediction process can be solved, and the processing speed of the image encoding process is increased. As a result, an image encoding process in real time may be more easily realized.

### (6) Two-Fold Parallel Prediction Processing

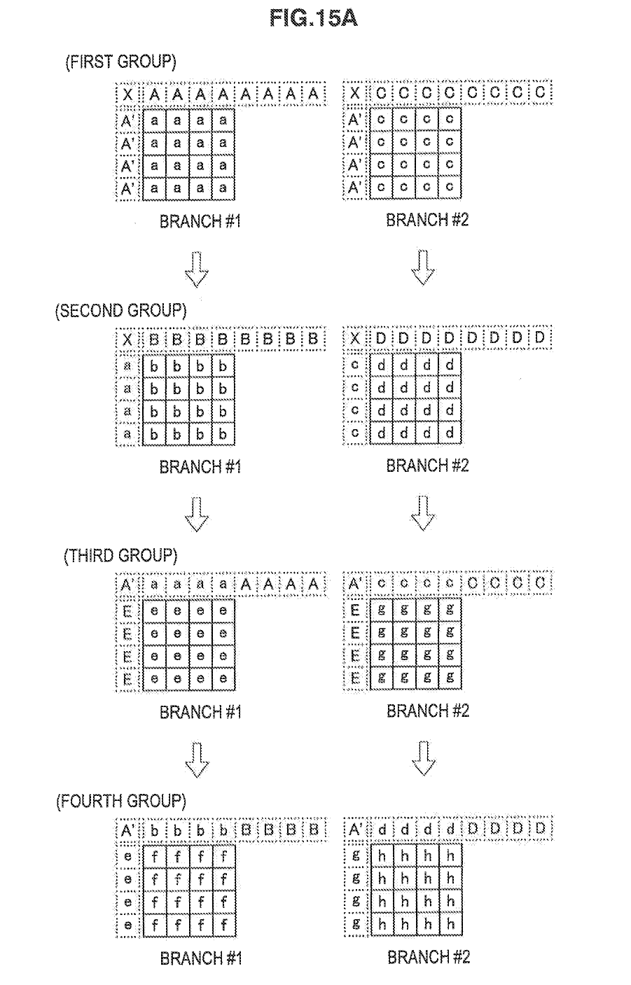

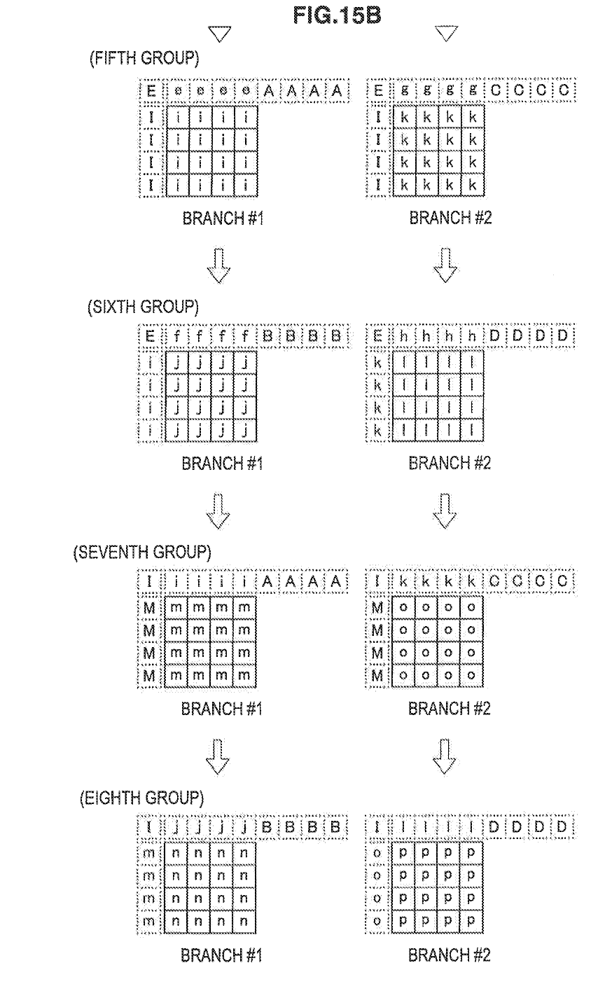

The number of processing branches at the time of parallelization of the intra prediction process is not limited to four described above. That is, the advantage of the technology described in the present specification may be enjoyed by two-fold parallel processing, eight-fold parallel processing and the like, FIGS. 15A and 15B are explanatory diagrams for describing two-fold parallel processing in the intra 4×4 prediction mode. Referring to FIGS. 15A and 15B, generation processing of a predicted pixel value for a pixel in the macro block MB shown in FIG. 8 is grouped into first, second, third, fourth, fifth, sixth, seventh and eighth groups.

The first group includes generation of a predicted pixel value for a pixel a in a first processing branch, and generation of a predicted pixel value for a pixel c in a second processing branch. The first processing branch uses pixels A as the reference pixels above and on the top right, a pixel X as the reference pixel on the top left, and pixels A′ as the reference pixels on the left. The second processing branch uses pixels C as the reference pixels above and on the top right, a pixel X as the reference pixel on the top left, and pixels A′ as the reference pixels on the left.

The second group includes generation of a predicted pixel value for a pixel b in the first processing branch, and generation of a predicted pixel value for a pixel d in the second processing branch. The first processing branch uses pixels B as the reference pixels above and on the top right, a pixel X as the reference pixel on the top left, and pixels a as the reference pixels on the left. The second processing branch uses pixels D as the reference pixels above and on the top right, a pixel X as the reference pixel on the top left, and pixels c as the reference pixels on the left.

The third group includes generation of a predicted pixel value for a pixel e in the first processing branch, and generation of a predicted pixel value for a pixel g in the second processing branch. The first processing branch uses pixels a as the reference pixels above, pixels A as the reference pixels on the top right, a pixel A′ as the reference pixel on the top left, and pixels E as the reference pixels on the left. The second processing branch uses pixels c as the reference pixels above, pixels C as the reference pixels on the top right, a pixel A′ as the reference pixel on the top left, and pixels E as the reference pixels on the left.

The fourth group includes generation of a predicted pixel value for a pixel f in the first processing branch, and generation of a predicted pixel value for a pixel h in the second processing branch. The first processing branch uses pixels b as the reference pixels above, pixels B as the reference pixels on the top right, a pixel A′ as the reference pixel on the top left, and pixels e as the reference pixels on the left. The second processing branch uses pixels d as the reference pixels above, pixels D as the reference pixels on the top right, a pixel A′ as the reference pixel on the top left, and pixels g as the reference pixels on the left.

Likewise, processing through the fifth group to the eighth group may be performed according to the contents shown in FIG. 15B.

### (7) Eight-Fold Parallel Prediction Processing

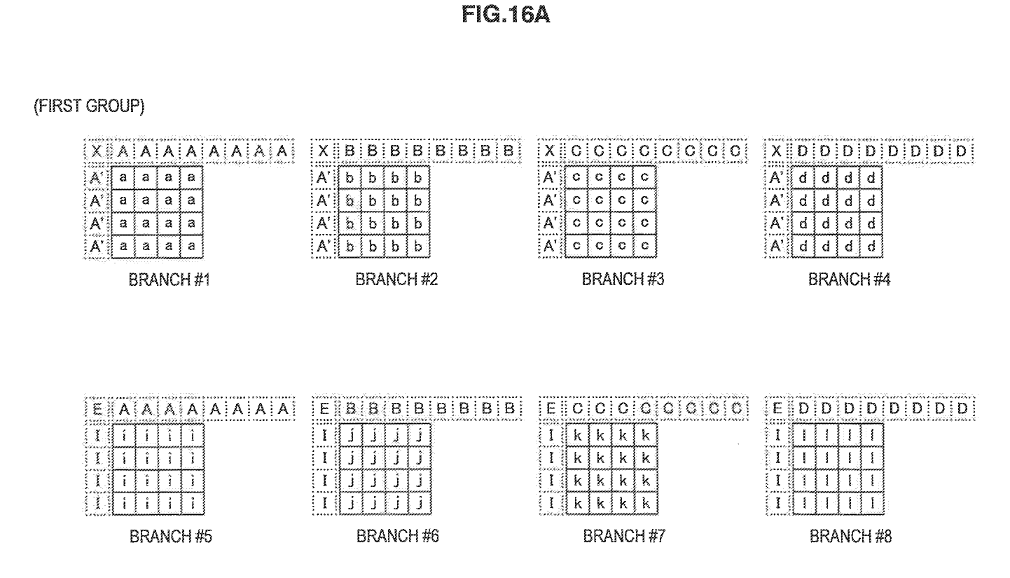

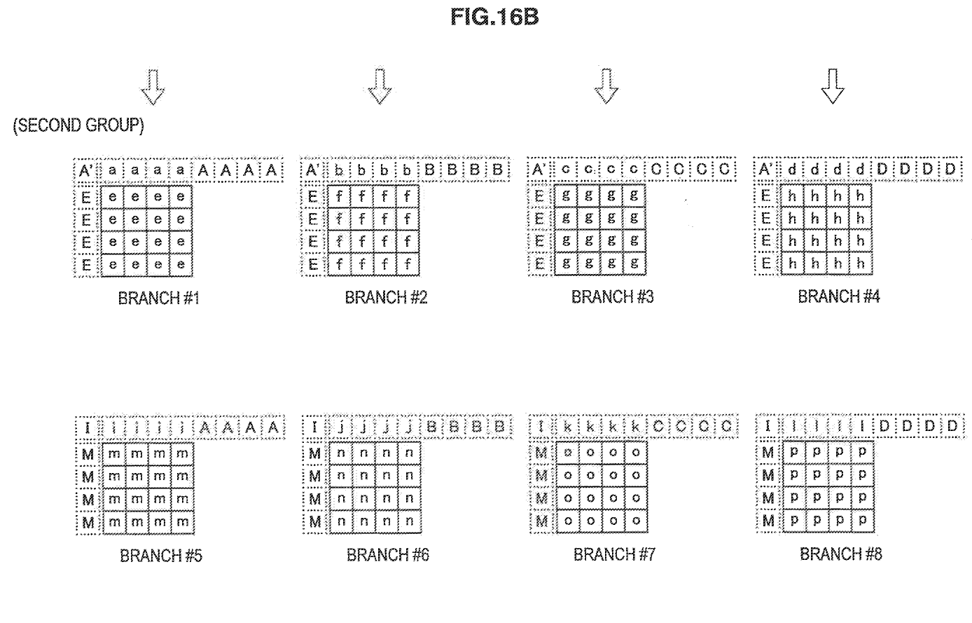

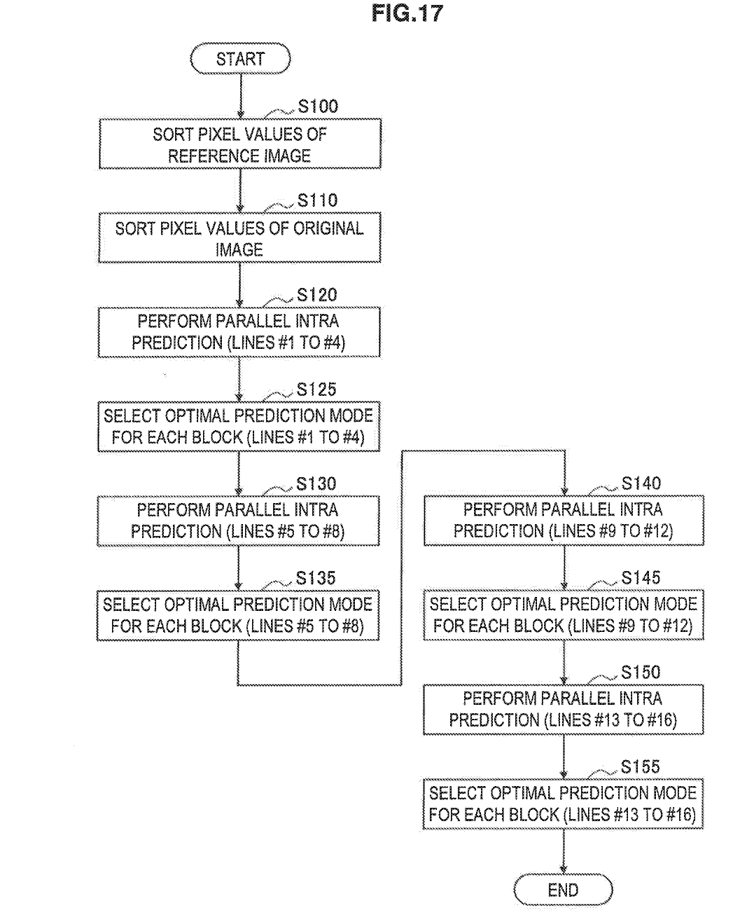

FIGS. 16A and 16B are explanatory diagrams for describing eight-fold parallel processing in the intra 4×4 prediction mode. Referring to FIGS. 16A and 16B, generation processing of a predicted pixel value for a pixel in the macro block MB shown in FIG. 8 is grouped into first and second groups,

The first group includes generation of a predicted pixel value for a pixel a in a first processing branch, generation of a predicted pixel value for a pixel b in a second processing branch, generation of a predicted pixel value for a pixel c in a third processing branch, generation of a predicted pixel value for a pixel d in a fourth processing branch, generation of a predicted pixel value for a pixel i in a fifth processing branch, generation of a predicted pixel value for a pixel j in a sixth processing branch, generation of a predicted pixel value for a pixel k in a seventh processing branch, and generation of a predicted pixel value for a pixel l in an eighth processing branch. The first processing branch uses pixels A as the reference pixels above and on the top right, a pixel X as the reference pixel on the top left, and pixels A′ as the reference pixels on the left. The second processing branch uses pixels B as the reference pixels above and on the top right, a pixel X as the reference pixel on the top left, and pixels A′ as the reference pixels on the left. The third processing branch uses pixels C as the reference pixels above and on the top right, a pixel X as the reference pixel on the top left, and pixels A′ as the reference pixels on the left. The fourth processing branch uses pixels D as the reference pixels above and on the top right, a pixel X as the reference pixel on the top left, and pixels A′ as the reference pixels on the left. The fifth processing branch uses pixels A as the reference pixels above and on the top right, a pixel E as the reference pixel on the top left, and pixels I as the reference pixels on the left. The sixth processing branch uses pixels B as the reference pixels above and on the top right, a pixel E as the reference pixel on the top left, and pixels I as the reference pixels on the left. The seventh processing branch uses pixels C as the reference pixels above and on the top right, a pixel E as the reference pixel on the top left, and pixels 1 as the reference pixels on the left. The eighth processing branch uses pixels D as the reference pixels above and on the top right, a pixel E as the reference pixel on the top left, and pixels I as the reference pixels on the left.

Likewise, processing of the second group may be performed according to the contents shown in Fig, 16B.

Additionally, the number of processing branches of parallel processing and the prediction accuracy of intra prediction are in a relationship of trade-off. If the number of processing branches of parallel processing is greatly increased, the distance from an encoding target pixel to a reference pixel becomes greater, possibly impairing the prediction accuracy of intra prediction. Accordingly, the number of processing branches of parallel processing is desirably selected taking into account the needs regarding the processing speed and the needs regarding the compression ratio or image quality and according to these needs.

### <2. Flow of Process at the Time of Encoding According to an Embodiment>

Next, a flow of a process at the time of encoding will be described using FIG. 17. FIG. 17 is a flow chart showing an example of a flow of the intra prediction process at the time of encoding of the intra prediction section 40 according to the present embodiment.

Referring to FIG. 17, first, the sorting section 41 sorts the reference pixel values included in reference image data supplied from the frame memory 25 according to the rule illustrated in FIG. 10 (step S100). Then, the sorting section 41 outputs a first portion of the series of reference pixel values after sorting to the first prediction section n42a, a second portion to the second prediction section 42b, a third portion to the third prediction section 42c, and a fourth portion to the fourth prediction section 42d.

Next, the sorting section 41 sorts pixel values included in a macro block in the original image according to the rule illustrated in FIG. 9 (step S110). Then, the sorting section 41 outputs a first portion of the series of pixel values after sorting to the first prediction section 42a, a second portion to the second prediction section 42b, a third portion to the third prediction section 42c, and a fourth portion to the fourth prediction section 42d.

Next, the first prediction section 42a, the second prediction section 42b, the third prediction section 42c and the fourth prediction section 42d perform the intra prediction process in parallel, taking the pixel values of first to fourth lines in the macro block as the targets, for example (step S120). Then, the first prediction section 42a, the second prediction section 42b, the third prediction section 42c and the fourth prediction section 42d each select an optimal prediction mode for each block (step S125). Prediction mode information indicating an optimal prediction mode selected here is output from the intra prediction section 40 to the lossless encoding section 16. Also, predicted pixel data including a predicted pixel value corresponding to an optimal prediction mode is output from the intra prediction section 40 to the subtraction section 13.

Next, the first prediction section 42a, the second prediction section 42b, the third prediction section 42c and the fourth prediction section 42d perform the intra prediction process in parallel, taking the pixel values of fifth to eighth lines in the macro block as the targets, for example (step S130). Then, the first prediction section 42a, the second prediction section 42b, the third prediction section 42c and the fourth prediction section 42d each select an optimal prediction mode for each block (step S135). Prediction mode information indicating an optimal prediction mode selected here is output from the intra prediction section 40 to the lossless encoding section 16. Also, predicted pixel data including a predicted pixel value corresponding to an optimal prediction mode is output from the intra prediction section 40 to the subtraction section 13.

Next, the first prediction section 42a, the second prediction section 42b, the third prediction section 42c and the fourth prediction section 42d perform the intra prediction process in parallel, taking the pixel values of ninth to twelfth lines in the macro block as the targets, for example (step S140). Then, the first prediction section 42a, the second prediction section 42b, the third prediction section 42c and the fourth prediction section 42d each select an optimal prediction mode for each block (step S145). Prediction mode information indicating an optimal prediction mode selected here is output from the intra prediction section 40 to the lossless encoding section 16. Also, predicted pixel data including a predicted pixel value corresponding to an optimal prediction mode is output from the intra prediction section 40 to the subtraction section 13.

Next, the first prediction section 42a, the second prediction section 42b, the third prediction section 42c and the fourth prediction section 42d perform the intra prediction process in parallel, taking the pixel values of thirteen to sixteenth lines in the macro block as the targets, for example (step S150). Then, the first prediction section 42a, the second prediction section 42b, the third prediction section 42c and the fourth prediction section 42d each select an optimal prediction mode for each block (step S155). Prediction mode information indicating an optimal prediction mode selected here is output from the intra prediction section 40 to the lossless encoding section 16. Also, predicted pixel data including a predicted pixel value corresponding to an optimal prediction mode is output from the intra prediction section 40 to the subtraction section 13.

### <3. Example Configuration of Image Decoding Device According to an Embodiment>

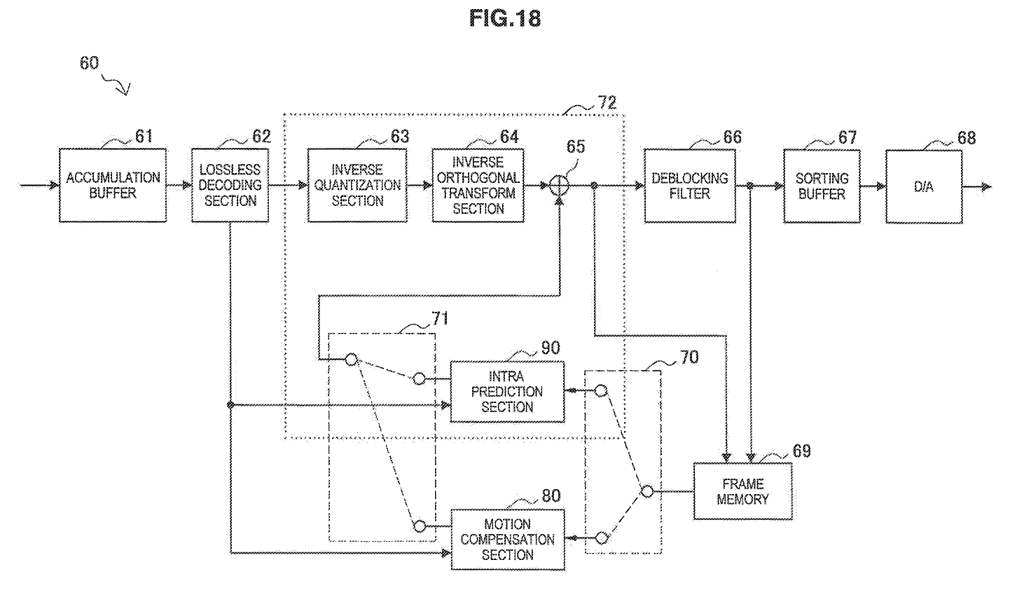

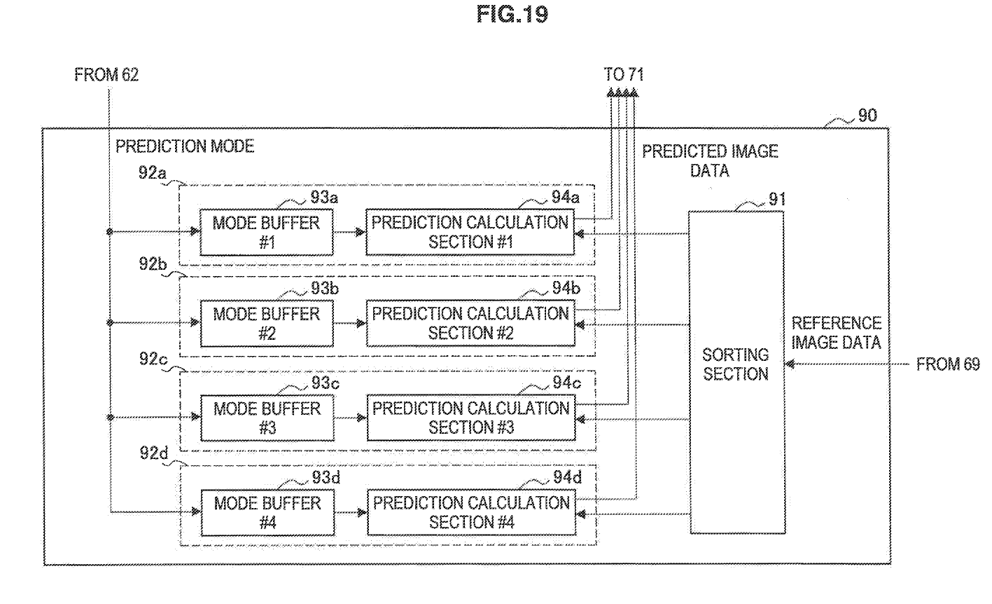

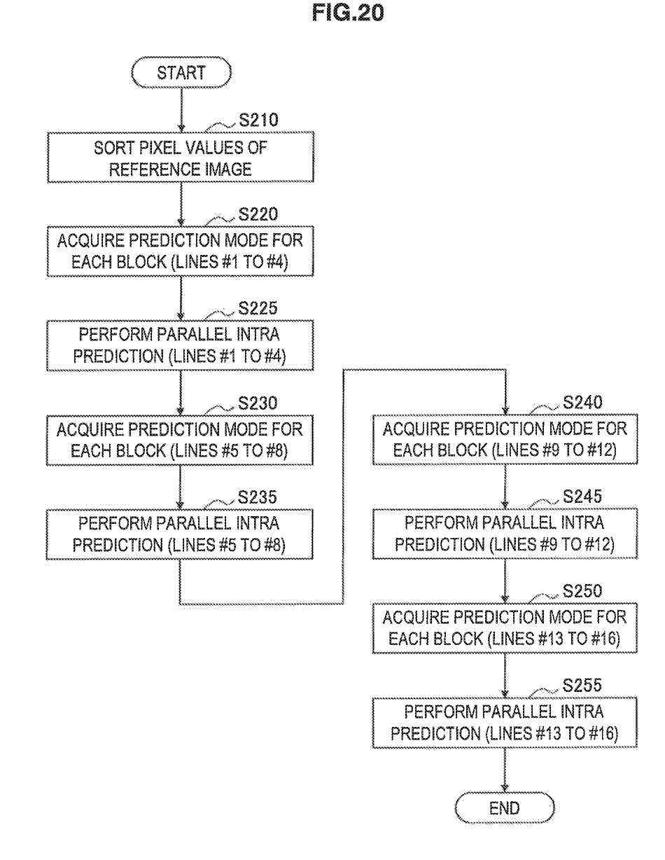

In this section, an example configuration of an image decoding device according to an embodiment will be described using FIGS. 18 and 19.

### [3-1. Example of Overall Configuration]

FIG. 18 is a block diagram showing an example of a configuration of an image decoding device 60 according to an embodiment. Referring to FIG. 18, the image decoding device 60 includes an accumulation buffer 61, a lossless decoding section 62, an inverse quantization section 63, an inverse orthogonal transform section 64, an addition section 65, a deblocking filter 66, a sorting buffer 67, a D/A (Digital to Analogue) conversion section 68, a frame memory 69, selectors 70 and 71, a motion compensation section 80 and an intra prediction section 90.

The accumulation buffer 61 temporarily stores an encoded stream input via a transmission line using a storage medium.

The lossless decoding section 62 decodes an encoded stream input from the accumulation buffer 61 according to the encoding method used at the time of encoding. Also, the lossless decoding section 62 decodes information multiplexed to the header region of the encoded stream. Information that is multiplexed to the header region of the encoded stream may include information about inter prediction and information about intra prediction in the block header, for example. The lossless decoding section 62 outputs the information about inter prediction to the motion compensation section 80. Also, the lossless decoding section 62 outputs the information about intra prediction to the intra prediction section 90.

The inverse quantization section 63 inversely quantizes quantized data which has been decoded by the lossless decoding section 62. The inverse orthogonal transform section 64 generates predicted error data by performing inverse orthogonal transformation on transform coefficient data input from the inverse quantization section 63 according to the orthogonal transformation method used at the time of encoding. Then, the inverse orthogonal transform section 64 outputs the generated predicted error data to the addition section 65.

The addition section 65 adds the predicted error data input from the inverse orthogonal transform section 64 and predicted image data input from the selector 71 to thereby generate decoded image data. Then, the addition section 65 outputs the generated decoded image data to the deblocking filter 66 and the frame memory 69.

The deblocking filter 66 removes block distortion by filtering the decoded image data input from the addition section 65, and outputs the decoded image data after filtering to the sorting buffer 67 and the frame memory 69.

The sorting buffer 67 generates a series of image data in a time sequence by sorting images input from the deblocking filter 66. Then, the sorting buffer 67 outputs the generated image data to the D/A conversion section 68.

The D/A conversion section 68 converts the image data in a digital format input from the sorting buffer 67 into an image signal in an analogue format. Then, the D/A conversion section 68 causes an image to be displayed by outputting the analogue image signal to a display (not shown) connected to the image decoding device 60, for example.

The frame memory 69 stores, using a storage medium, the decoded image data before filtering input from the addition section 65, and the decoded image data after filtering input from the deblocking filter 66.

The selector 70 switches the output destination of the image data from the frame memory 69 between the motion compensation section 80 and the intra prediction section 90 for each block in the image according to mode information acquired by the lossless decoding section 62. For example, in the case the inter prediction mode is specified, the selector 70 outputs the decoded image data after filtering that is supplied from the frame memory 69 to the motion compensation section 80 as the reference image data. Also, in the case the intra prediction mode is specified, the selector 70 outputs the decoded image data before filtering that is supplied from the frame memory 69 to the intra prediction section 90 as reference image data.

The selector 71 switches the output source of predicted image data to be supplied to the addition section 65 between the motion compensation section 80 and the intra prediction section 90 according to the mode information acquired by the lossless decoding section 62. For example, in the case the inter prediction mode is specified, the selector 71 supplies to the addition section 65 the predicted image data output from the motion compensation section 80. Also, in the case the intra prediction mode is specified, the selector 71 supplies to the addition section 65 the predicted image data output from the intra prediction section 90.

The motion compensation section 80 performs a motion compensation process based on the information about inter prediction input from the lossless decoding section 62 and the reference image data from the frame memory 69, and generates predicted image data. Then, the motion compensation section 80 outputs the generated predicted image data to the selector 71.

The intra prediction section 90 performs an intra prediction process based on the information about intra prediction input from the lossless decoding section 62 and the reference image data from the frame memory 69, and generates predicted image data. Then, the intra prediction section 90 outputs the generated predicted image data to the selector 71. In the present embodiment, the intra prediction process of the intra prediction section 90 is parallelized by a plurality of processing branches. Parallel intra prediction processing by the intra prediction section 90 will be described later in detail.

With the parallelization of the intra prediction process of the intra prediction section 90, the processing, related to the intra prediction mode, of the inverse quantization section 63, the inverse orthogonal transform section 64 and the addition section 65 described above may also be parallelized. In this case, as shown in FIG. 18, the inverse quantization section 63, the inverse orthogonal transform section 64, the addition section 65 and the intra prediction section 90 form a parallel processing segment 72. Also, each section in the parallel processing segment 72 includes a plurality of processing branches. Each section in the parallel processing segment 72 may, while performing parallel processing in the intra prediction mode using a plurality of processing branches, use only one processing branch in the inter prediction mode.

### [3-2. Example Configuration of Intra Prediction Section]

FIG. 19 is a block diagram showing an example of a detailed configuration of the intra prediction section 90 of the image decoding device 60 shown in FIG. 18. Referring to FIG. 19, the intra prediction section 90 includes a sorting section 91, and four prediction sections 92a to 92d. That is, in the example of FIG. 19, the intra prediction section 90 includes four processing branches that are arranged in parallel. However, the number of processing branches of the intra prediction section 90 is not limited to such an example. For example, the intra prediction section 90 may include two or eight processing branches.

The sorting section 91 sorts reference pixel values included in reference image data supplied from the frame memory 69 according to a predetermined rule. The reference image data supplied from the frame memory 69 to the intra prediction section 90 is data of an already decoded portion of an image same as a decoding target image. Then, the sorting section 91 outputs a first portion of a series of reference pixel values after sorting to the first prediction section 92a, a second portion to the second prediction section 92b, a third portion to the third prediction section 92c, and a fourth portion to the fourth prediction section 92d.

The rule of sorting of the pixel values of reference pixels by the sorting section 91 is the rule described using FIG. 10, for example. That is, the sorting section 91 causes the pixel value of a first reference pixel adjacent to a first pixel of a first sub-block included in a macro block MB in an image and the pixel value of a second reference pixel adjacent to a second pixel of a second sub-block included in the macro block MB to be in succession. The pixel positions of the first pixel and the second pixel in the sub-blocks may be the same position. For example, the first pixel is a pixel a of the sub-block SB1, the second pixel is a pixel a of the sub-block SB2, the first reference pixel is a reference pixel A above the pixel a of the sub-block SB1, and the second reference pixel is a reference pixel A above the pixel a of the second sub-block SB2 (see FIGS. 8 to 10), In the case of four-fold parallel, the sorting section 41 further causes the pixel values of a reference pixel A above a pixel a of a sub-block SB3 and a reference pixel A above a pixel a of a sub-block SB4, and the pixel values of four reference pixels A on the right to be in succession to the pixel values of the first reference pixel and the second reference pixel. The sorting section 41 successively outputs the pixel values of the eight reference pixels A to the first prediction section 92a (branch #1 in FIG. 10),

Likewise, the sorting section 91 causes the pixel value of a third reference pixel adjacent to a third pixel of the first sub-bock included in the macro block MB in the image and the pixel value of a fourth reference pixel adjacent to a fourth pixel of the second sub-block included in the macro block MB to be in succession. The pixel positions of the third pixel and the fourth pixel in the sub-blocks may be the same position. For example, the third pixel is a pixel b of the sub-block SB1, the fourth pixel is a pixel b of the sub-block SB2, the third reference pixel is a reference pixel B above the pixel b of the sub-block SB1, and the second reference pixel is a reference pixel B above the pixel b of the second sub-block SB2 (see FIGS. 8 to 10). In the case of four-fold parallel, the sorting section 41 further causes the pixel values of a reference pixel B above a pixel b of the sub-block SB3 and a reference pixel B above a pixel b of the sub-block SB4, and the pixel values of four reference pixels B on the right to be in succession to the pixel values of the third reference pixel and the fourth reference pixel. The sorting section 41 successively outputs the pixel values of the eight reference pixels B to the first prediction section 92a (branch #2 in FIG. 10).

Likewise, the sorting section 91 successively outputs the pixel values of reference pixels C above pixels c of the sub-blocks SB1 to SB4 to the third prediction section 92c (branch #3 in FIG. 10), Furthermore, the sorting section 91 successively outputs the pixel values of reference pixels D above pixels d of the sub-blocks SB1 to SB4 to the fourth prediction section 92d (branch #4 in FIG. 10).

The prediction sections 92a to 92d generate predicted pixel values for a decoding target macro block using the pixel values of the reference pixels which have been sorted by the sorting section 91.

More specifically, the first prediction section 92a includes a first mode buffer 93a and a first prediction calculation section 94a. The first mode buffer 93a acquires prediction mode information included in the information about intra prediction input from the lossless decoding section 62, and temporarily stores the acquired prediction mode information using a storage medium. The prediction mode information includes information (for example, the intra 4×4 prediction mode, the intra 8×8 prediction mode or the like) indicating the size of a sub-block, which is a unit of processing of intra prediction, for example. Furthermore, the prediction mode information includes information (for example, any of Mode 0 to Mode 8) indicating the prediction direction selected, from a plurality of prediction directions, as being optimal at the time of encoding of the image, for example. Also, the prediction mode information may include information specifying that an estimated prediction mode is to be used, but in this case, the prediction mode information does not include a prediction mode number indicating the prediction direction.

The first prediction calculation section 94a calculates predicted pixel values from the reference pixel values sorted by the sorting section 91, according to the prediction mode information stored in the first mode buffer 93a. For example, in the case the prediction mode information indicates Mode 0 in the intra 4×4 prediction mode, the first prediction calculation section 94a sets the predicted pixel value for a decoding target pixel to a value same as the reference pixel value above the pixel (see Mode 0 in FIG. 3). After such processing, the first prediction section 92a outputs predicted image data including the predicted pixel values calculated by the first prediction calculation section 94a to the selector 71.

The second prediction section 92b includes a second mode buffer 93b and a second prediction calculation section 94b. The third prediction section 92c includes a third mode buffer 93c and a third prediction calculation section 94c. The fourth prediction section 92d includes a fourth mode buffer 93d and a fourth prediction calculation section 94d. In the similar manner to the first prediction section 92a, the second prediction section 92b, the third prediction section 92c and the fourth prediction section 92d each generate predicted pixel values from the pixel values of reference pixels sorted by the sorting section 91, according to the prediction mode information included in the information about intra prediction. Then, the second prediction section 92b, the third prediction section 92c and the fourth prediction section 92d output predicted image data including the generated predicted pixel values to the selector 71 in parallel.

### <4. Flow of Process at the Time of Decoding According to an Embodiment>

Next, a flow of a process at the time of decoding will be described using FIG. 20. FIG. 20 is a flow chart showing an example of a flow of the intra prediction process at the time of decoding of the intra prediction section 40 according to the present embodiment.

Referring to FIG. 20, first, the sorting section 91 sorts reference pixel values included in reference image data supplied from the frame memory 69 according to the rule illustrated in FIG. 10 (step S210). Then,, the sorting section 91 outputs the sorted reference pixel values to the first prediction section 92a, the second prediction section 92b, the third prediction section 92c and the fourth prediction section 92d.

Next, the first prediction section 92a, the second prediction section 92b, the third prediction section 92c and the fourth prediction section 92d each acquire prediction mode information input from the lossless decoding section 62 (step S220). Next, the first prediction section 92a, the second prediction section 92b, the third prediction section 92c and the fourth prediction section 92d perform the intra prediction process in parallel, taking the pixel values of the first to fourth lines in the macro block as the targets, for example (step S225). Then, the first prediction section 92a, the second prediction section 92b, the third prediction section 92c and the fourth prediction section 92d each output, to the addition section 65, predicted pixel data including predicted pixel values generated from reference pixel values according to the prediction mode information.

Next, the first prediction section 92a, the second prediction section 92b, the third prediction section 92c and the fourth prediction section 92d each acquire again the prediction mode information input from the lossless decoding section 62 (step S230). Then, the first prediction section 92a, the second prediction section 92b, the third prediction section 92c and the fourth prediction section 92d perform the intra prediction process in parallel, taking the pixel values of the fifth to eighth lines in the macro block as the targets, for example (step S235). Then, the first prediction section 92a, the second prediction section 92b, the third prediction section 92c and the fourth prediction section 92d each output, to the addition section 65, predicted pixel data including predicted pixel values generated from reference pixel values according to the prediction mode information.

Next, the first prediction section 92a, the second prediction section 92b, the third prediction section 92c and the fourth prediction section 92d each acquire again the prediction mode information input from the lossless decoding section 62 (step S240). Then, the first prediction section 92a, the second prediction section 92b, the third prediction section 92c and the fourth prediction section 92d perform the intra prediction process in parallel, taking the pixel values of the ninth to twelfth lines in the macro block as the targets, for example (step S245). Then, the first prediction section 92a, the second prediction section 92b, the third prediction section 92c and the fourth prediction section 92d each output, to the addition section 65, predicted pixel data including predicted pixel values generated from reference pixel values according to the prediction mode information.

Next, the first prediction section 92a, the second prediction section 92b, the third prediction section 92c and the fourth prediction section 92d each acquire again the prediction mode information input from the lossless decoding section 62 (step S250). Then, the first prediction section 92a, the second prediction section 92b, the third prediction section 92c and the fourth prediction section 92d perform the intra prediction process in parallel, taking the pixel values of the thirteenth to sixteenth lines in the macro block as the targets, for example (step S255). Then, the first prediction section 92a, the second prediction section 92b, the third prediction section 92c and the fourth prediction section 92d each output, to the addition section 65, predicted pixel data including predicted pixel values generated from reference pixel values according to the prediction mode information.

### <5. Example Application>

The image encoding device 10 and the image decoding device 60 according to the embodiment described above may be applied to various electronic appliances such as a transmitter and a receiver for satellite broadcasting, cable broadcasting such as cable TV, distribution on the Internet, distribution to terminals via cellular communication, and the like, a recording device that records images in a medium such as an optical disc, a magnetic disk or a flash memory, a reproduction device that reproduces images from such storage medium, and the like. Four example applications will be described below.

### [5-1. First Example Application]

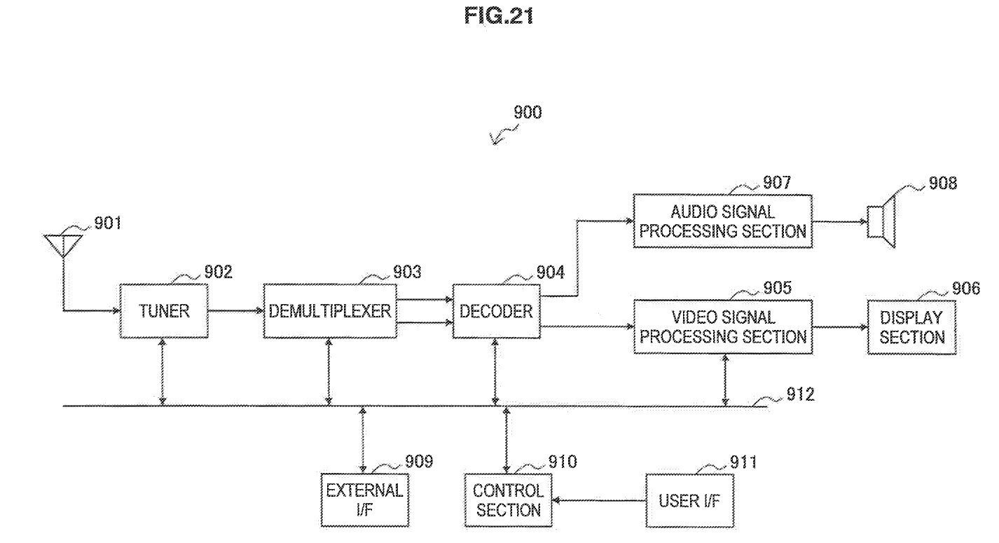

FIG. 21 is a block diagram showing an example of a schematic configuration of a television adopting the embodiment described above. A television 900 includes an antenna 901, a tuner 902, a demultiplexer 903, a decoder 904, an video signal processing section 905, a display section 906, an audio signal processing section 907, a speaker 908, an external interface 909, a control section 910, a user interface 911, and a bus 912.

The tuner 902 extracts a signal of a desired channel from broadcast signals received via the antenna 901, and demodulates the extracted signal. Then, the tuner 902 outputs an encoded bit stream obtained by demodulation to the demultiplexer 903. That is, the tuner 902 serves as transmission means of the televisions 900 for receiving an encoded stream in which an image is encoded.

The demultiplexer 903 separates a video stream and an audio stream of a program to be viewed from the encoded bit stream, and outputs each stream which has been separated to the decoder 904. Also, the demultiplexer 903 extracts auxiliary data such as an EPG (Electronic Program Guide) from the encoded bit stream, and supplies the extracted data to the control section 910. Additionally, the demultiplexer 903 may perform descrambling in the case the encoded bit stream is scrambled.

The decoder 904 decodes the video stream and the audio stream input from the demultiplexer 903. Then, the decoder 904 outputs video data generated by the decoding process to the video signal processing section 905. Also, the decoder 904 outputs the audio data generated by the decoding process to the audio signal processing section 907.

The video signal processing section 905 reproduces the video data input from the decoder 904, and causes the display section 906 to display the video. The video signal processing section 905 may also cause the display section 906 to display an application screen supplied via a network. Further, the video signal processing section 905 may perform an additional process such as noise removal, for example, on the video data according to the setting. Furthermore, the video signal processing section 905 may generate an image of a GUI (Graphical User Interface) such as a menu, a button, a cursor or the like, for example, and superimpose the generated image on an output image.

The display section 906 is driven by a drive signal supplied by the video signal processing section 905, and displays a video or an image on an video screen of a display device (for example, a liquid crystal display, a plasma display, an OLED, or the like).

The audio signal processing section 907 performs reproduction processes such as D/A conversion and amplification on the audio data input from the decoder 904, and outputs audio from the speaker 908. Also, the audio signal processing section 907 may perform an additional process such as noise removal on the audio data.

The external interface 909 is an interface for connecting the television 900 and an external appliance or a network. For example, a video stream or an audio stream received via the external interface 909 may be decoded by the decoder 904. That is, the external interface 909 also serves as transmission means of the televisions 900 for receiving an encoded stream in which an image is encoded.

The control section 910 includes a processor such as a CPU (Central Processing Unit), and a memory such as an RAM (Random Access Memory), an ROM (Read Only Memory), or the like. The memory stores a program to be executed by the CPU, program data, EPG data, data acquired via a network, and the like. The program stored in the memory is read and executed by the CPU at the time of activation of the television 900, for example. The CPU controls the operation of the television 900 according to an operation signal input from the user interface 911, for example, by executing the program.

The user interface 911 is connected to the control section 910. The user interface 911 includes a button and a switch used by a user to operate the television 900, and a receiving section for a remote control signal, for example. The user interface 911 detects an operation of a user via these structural elements, generates an operation signal, and outputs the generated operation signal to the control section 910.

The bus 912 interconnects the tuner 902, the demultiplexer 903, the decoder 904, the video signal processing section 905, the audio signal processing section 907, the external interface 909, and the control section 910.

In the television 900 configured in this manner, the decoder 904 has a function of the image decoding device 60 according to the embodiment described above. Accordingly, in the television 900, it is possible to parallelize the intra prediction process and to reduce the processing time required for intra prediction,

### [5-2. Second Example Application]

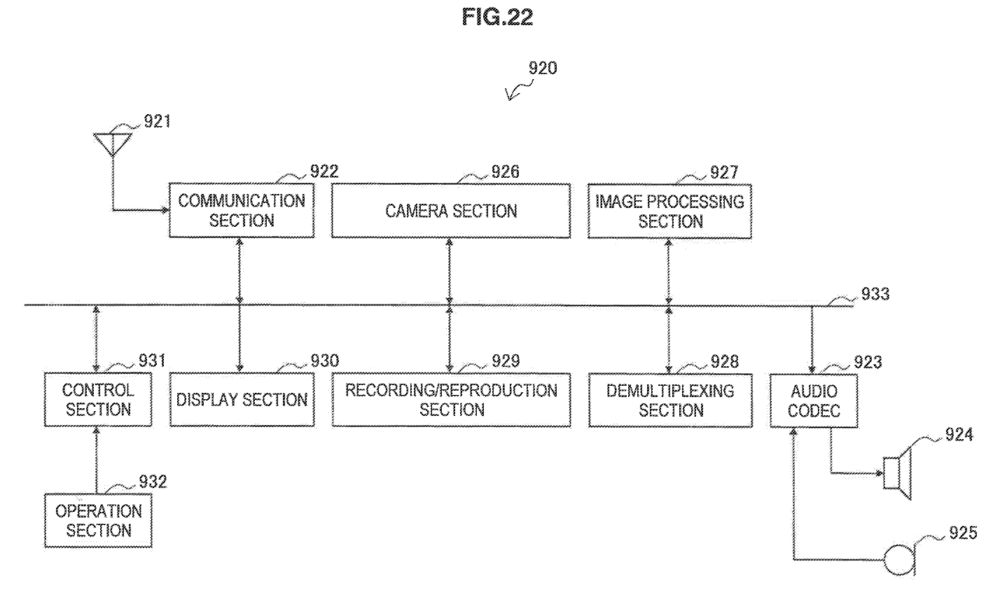

FIG. 22 is a block diagram showing an example of a schematic configuration of a mobile phone adopting the embodiment described above. A mobile phone 920 includes an antenna 921, a communication section 922, an audio codec 923, a speaker 924, a microphone 925, a camera section 926, an image processing section 927, a demultiplexing section 928, a recording/reproduction section 929, a display section 930, a control section 931, an operation section 932, and a bus 933.

The antenna 921 is connected to the communication section 922. The speaker 924 and the microphone 925 are connected to the audio codec 923. The operation section 932 is connected to the control section 931. The bus 933 interconnects the communication section 922, the audio codec 923, the camera section 926, the image processing section 927, the demultiplexing section 928, the recording/reproduction section 929, the display section 930, and the control section 931.

The mobile phone 920 performs operation such as transmission/reception of audio signal, transmission/reception of emails or image data, image capturing, recording of data, and the like, in various operation modes including an audio communication mode, a data communication mode, an image capturing mode, and a videophone mode.

In the audio communication mode, an analogue audio signal generated by the microphone 925 is supplied to the audio codec 923. The audio codec 923 converts the analogue audio signal into audio data, and A/D converts and compresses the converted audio data. Then, the audio codec 923 outputs the compressed audio data to the communication section 922. The communication section 922 encodes and modulates the audio data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal and generates audio data, and outputs the generated audio data to the audio codec 923. The audio codec 923 extends and D/A converts the audio data, and generates an analogue audio signal. Then, the audio codec 923 supplies the generated audio signal to the speaker 924 and causes the audio to be output.

Also, in the data communication mode, the control section 931 generates text data that makes up an email, according to an operation of a user via the operation section 932, for example. Moreover, the control section 931 causes the text to be displayed on the display section 930. Furthermore, the control section 931 generates email data according to a transmission instruction of the user via the operation section 932, and outputs the generated email data to the communication section 922. Then, the communication section 922 encodes and modulates the email data, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. Then, the communication section 922 demodulates and decodes the received signal, restores the email data, and outputs the restored email data to the control section 931. The control section 931 causes the display section 930 to display the contents of the email, and also, causes the email data to be stored in the storage medium of the recording/reproduction section 929.

The recording/reproduction section 929 includes an arbitrary readable and writable storage medium. For example, the storage medium may be a built-in storage medium such as an RAM, a flash memory or the like, or an externally mounted storage medium such as a hard disk, a magnetic disk, a magneto-optical disk, an optical disc, an USB memory, a memory card, or the like.

Furthermore, in the image capturing mode, the camera section 926 captures an image of a subject, generates image data, and outputs the generated image data to the image processing section 927, for example. The image processing section 927 encodes the image data input from the camera section 926, and causes the encoded stream to be stored in the storage medium of the recording/reproduction section 929.

Furthermore, in the videophone mode, the demultiplexing section 928 multiplexes a video stream encoded by the image processing section 927 and an audio stream input from the audio codec 923, and outputs the multiplexed stream to the communication section 922, for example. The communication section 922 encodes and modulates the stream, and generates a transmission signal. Then, the communication section 922 transmits the generated transmission signal to a base station (not shown) via the antenna 921. Also, the communication section 922 amplifies a wireless signal received via the antenna 921 and converts the frequency of the wireless signal, and acquires a received signal. These transmission signal and received signal may include an encoded hit stream, Then, the communication section 922 demodulates and decodes the received signal, restores the stream, and outputs the restored stream to the demultiplexing section 928. The demultiplexing section 928 separates a video stream and an audio stream from the input stream, and outputs the video stream to the image processing section 927 and the audio stream to the audio codec 923. The image processing section 927 decodes the video stream, and generates video data. The video data is supplied to the display section 930, and a series of images is displayed by the display section 930. The audio codec 923 extends and D/A. converts the audio stream, and generates an analogue audio signal. Then, the audio codec 923 supplies the generated audio signal to the speaker 924 and causes the audio to be output.

In the mobile phone 920 configured in this manner, the image processing section 927 has a function of the image encoding device 10 and the image decoding device 60 according to the embodiment described above. Accordingly, in the mobile phone 920, it is possible to parallelize the intra prediction process and to reduce the processing time required for intra prediction.

### [5-3. Third Example Application]

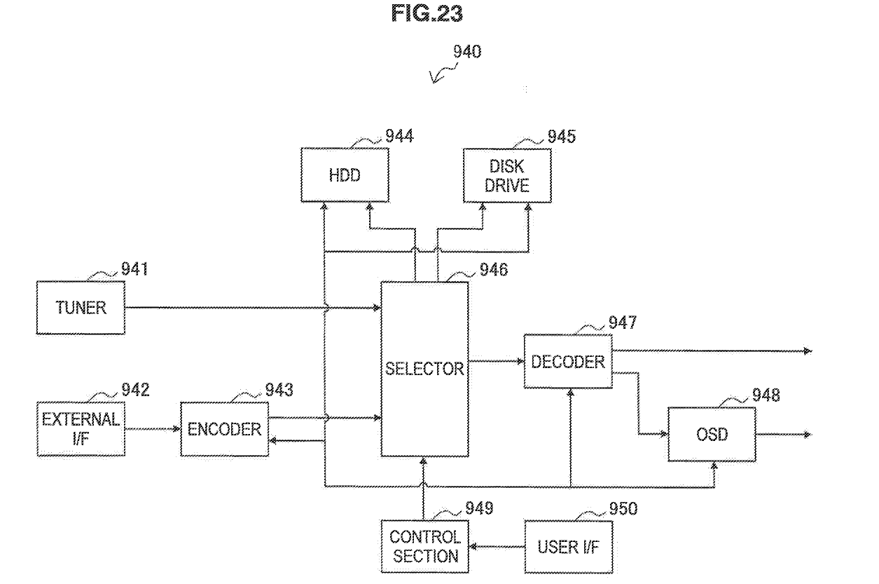

FIG. 23 is a block diagram showing an example of a schematic configuration of a recording/reproduction device adopting the embodiment described above. A recording/reproduction device 940 encodes, and records in a recording medium, audio data and video data of a received broadcast program, for example. The recording/reproduction device 940 may also encode, and record in the recording medium, audio data and video data acquired from another device, for example. Furthermore, the recording/reproduction device 940 reproduces, using a monitor or a speaker, data recorded in the recording medium, according to an instruction of a user, for example. At this time, the recording/reproduction device 940 decodes the audio data and the video data.

The recording/reproduction device 940 includes a tuner 941, an external interface 942, an encoder 943, an HDD (Hard Disk Drive) 944, a disc drive 945, a selector 946, a decoder 947, an OSD (On-Screen Display) 948, a control section 949, and a user interface 950.

The tuner 941 extracts a signal of a desired channel from broadcast signals received via an antenna (not shown), and demodulates the extracted signal. Then, the tuner 941 outputs an encoded bit stream obtained by demodulation to the selector 946. That is, the tuner 941 serves as transmission means of the recording/reproduction device 940.

The external interface 942 is an interface for connecting the recording/reproduction device 940 and an external appliance or a network. For example, the external interface 942 may be an IEEE 1394 interface, a network interface, an USB interface, a flash memory interface, or the like. For example, video data and audio data received by the external interface 942 are input to the encoder 943. That is, the external interface 942 serves as transmission means of the recording/reproduction device 940.

In the case the video data and the audio data input from the external interface 942 are not encoded, the encoder 943 encodes the video data and the audio data. Then, the encoder 943 outputs the encoded bit stream to the selector 946.

The HDD 944 records in an internal hard disk an encoded bit stream, which is compressed content data of a video or audio, various programs, and other pieces of data. Also, the HDD 944 reads these pieces of data from the hard disk at the time of reproducing a video or audio.

The disc drive 945 records or reads data in a recording medium that is mounted. A recording medium that is mounted on the disc drive 945 may be a DVD disc (a DVD-Video, a DVD-RAM, a DVD-R, a DVD-RW, a DVD+, a DVD+RW, or the like), a Blu-ray (registered trademark) disc, or the like, for example.

The selector 946 selects, at the time of recording a video or audio, an encoded bit stream input from the tuner 941 or the encoder 943, and outputs the selected encoded bit stream to the HDD 944 or the disc drive 945. Also, the selector 946 outputs, at the time of reproducing a video or audio, an encoded hit stream input from the HDD 944 or the disc drive 945 to the decoder 947.

The decoder 947 decodes the encoded bit stream, and generates video data and audio data. Then, the decoder 947 outputs the generated video data to the OSD 948. Also, the decoder 904 outputs the generated audio data to an external speaker.

The OSD 948 reproduces the video data input from the decoder 947, and displays a video. Also, the OSD 948 may superimpose an image of a GUI, such as a menu, a button, a cursor or the like, for example, on a displayed video.

The control section 949 includes a processor such as a CPU, and a memory such as an RAM or an ROM. The memory stores a program to be executed by the CPU, program data, and the like. A program stored in the memory is read and executed by the CPU at the time of activation of the recording/reproduction device 940, for example. The CPU controls the operation of the recording/reproduction device 940 according to an operation signal input from the user interface 950, for example, by executing the program.

The user interface 950 is connected to the control section 949. The user interface 950 includes a button and a switch used by a user to operate the recording/reproduction device 940, and a receiving section for a remote control signal, for example. The user interface 950 detects an operation of a user via these structural elements, generates an operation signal, and outputs the generated operation signal to the control section 949.

In the recording/reproduction device 940 configured in this manner, the encoder 943 has a function of the image encoding device 10 according to the embodiment described above. Also, the decoder 947 has a function of the image decoding device 60 according to the embodiment described above. Accordingly, in the recording/reproduction device 940, it is possible to parallelize the intra prediction process and to reduce the processing time required for intra prediction.

### [5-4. Fourth Example Application]

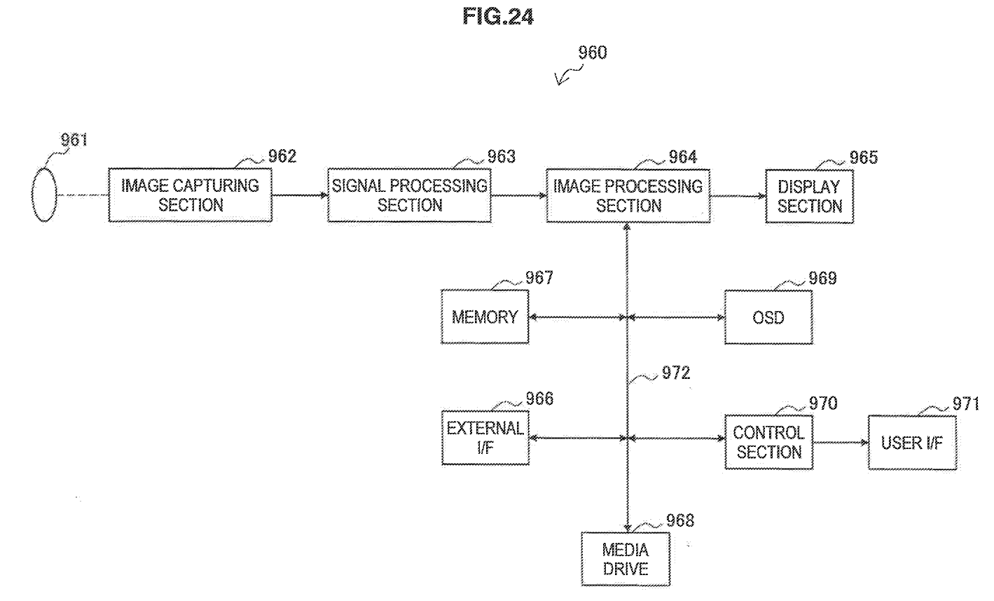

FIG. 24 is a block diagram showing an example of a schematic configuration of an image capturing device adopting the embodiment described above. An image capturing device 960 captures an image of a subject, generates an image, encodes the image data, and records the image data in a recording medium.

The image capturing device 960 includes an optical block 961, an image capturing section 962, a signal processing section 963, an image processing section 964, a display section 965, an external interface 966, a memory 967, a media drive 968, an OSD 969, a control section 970, a user interface 971, and a bus 972.

The optical block 961 is connected to the image capturing section 962. The image capturing section 962 is connected to the signal processing section 963. The display section 965 is connected to the image processing section 964. The user interface 971 is connected to the control section 970. The bus 972 interconnects the image processing section 964, the external interface 966, the memory 967, the media drive 968, the OSD 969, and the control section 970.

The optical block 961 includes a focus lens, an aperture stop mechanism, and the like. The optical block 961 forms an optical image of a subject on an image capturing surface of the image capturing section 962. The image capturing section 962 includes an image sensor such as a CCD, a CMOS or the like, and converts by photoelectric conversion the optical image formed on the image capturing surface into an image signal which is an electrical signal. Then, the image capturing section 962 outputs the image signal to the signal processing section 963.

The signal processing section 963 performs various camera signal processes, such as knee correction, gamma correction, color correction and the like, on the image signal input from the image capturing section 962. The signal processing section 963 outputs the image data after the camera signal process to the image processing section 964.

The image processing section 964 encodes the image data input from the signal processing section 963, and generates encoded data. Then, the image processing section 964 outputs the generated encoded data to the external interface 966 or the media drive 968. Also, the image processing section 964 decodes encoded data input from the external interface 966 or the media drive 968, and generates image data. Then, the image processing section 964 outputs the generated image data to the display section 965. Also, the image processing section 964 may output the image data input from the signal processing section 963 to the display section 965, and cause the image to be displayed. Furthermore, the image processing section 964 may superimpose data for display acquired from the OSD 969 on an image to be output to the display section 965.

The OSD 969 generates an image of a GUI, such as a menu, a button, a cursor or the like, for example, and outputs the generated image to the image processing section 964.

The external interface 966 is configured as an USB input/output terminal, for example. The external interface 966 connects the image capturing device 960 and a printer at the time of printing an image, for example. Also, a drive is connected to the external interface 966 as necessary. A removable medium, such as a magnetic disk, an optical disc or the like, for example, is mounted on the drive, and a program read from the removable medium may be installed in the image capturing device 960. Furthermore, the external interface 966 may be configured as a network interface to be connected to a network such as a LAN, the Internet or the like. That is, the external interface 966 serves as transmission means of the image capturing device 960.

A recording medium to be mounted on the media drive 968 may be an arbitrary readable and writable removable medium, such as a magnetic disk, a magneto-optical disk, an optical disc, a semiconductor memory or the like, for example. Also, a recording medium may be fixedly mounted on the media drive 968, configuring a non-transportable storage section such as a built-in hard disk drive or an SSD (Solid State Drive), for example.

The control section 970 includes a processor such as a CPU, and a memory such as an RAM or an ROM. The memory stores a program to be executed by the CPU, program data, and the like. A program stored in the memory is read and executed by the CPU at the time of activation of the image capturing device 960, for example. The CPU controls the operation of the image capturing device 960 according to an operation signal input from the user interface 971, for example, by executing the program.

The user interface 971 is connected to the control section 970. The user interface 971 includes a button, a switch and the like used by a user to operate the image capturing device 960, for example. The user interface 971 detects an operation of a user via these structural elements, generates an operation signal, and outputs the generated operation signal to the control section 970.

In the image capturing device 960 configured in this manner, the image processing section 964 has a function of the image encoding device 10 and the image decoding device 60 according to the embodiment described above. Accordingly, in the image capturing device 960, it is possible to parallelize the intra prediction process and to reduce the processing time required for intra prediction.

### <6. Summary>

Heretofore, the image encoding device 10 and the image decoding device 60 according to an embodiment have been described using FIGS. 1 to 24. According to the present embodiment, at the time of encoding an image in the intra prediction mode, after pixel values included in an original image and pixel values included in a reference image are sorted according to a predetermined rule, generation of predicted pixel values and determination of an optimal prediction mode are performed in parallel by a plurality of prediction sections. Also, at the time of decoding the image, after the pixel values included in the reference image are sorted according to a predetermined rule, predicted pixel values are generated in parallel by a plurality of prediction sections according to prediction modes selected at the time of encoding of the image. The bottleneck in the intra prediction process can thereby be solved, and the processing speed of the image encoding process and the image decoding process increases. As a result, real time processing is more easily realized, for example.

Also, according to the present embodiment, pixel values of pixels at the same position in different sub-blocks are sorted to be in succession, and are input to one prediction section. Therefore, as shown in FIGS. 11A and 11B, for example, each prediction section can each perform calculation of predicted pixel values for pixel values that are successively input, using one set of common reference pixel values.

Further, according to the present embodiment, pixels that are processed in parallel by a plurality of prediction sections are pixels belonging to the same line in an image. Accordingly, the memory resources required for the sorting process before the parallel processing is prevented from increasing.

Furthermore, according to the rule of sorting in the present embodiment, each prediction section is capable of generating, based on the predicted pixel value generated for a pixel belonging to a certain line, the predicted pixel value for a pixel belonging to the next line. Accordingly, candidates of prediction mode defined by H.264/AVC can be adopted even in the case of parallelizing the intra prediction process.

Furthermore, according to the present embodiment, each prediction section can reduce the bit rate of the prediction mode information by estimating the prediction direction (prediction mode), even in the case of parallelizing the intra prediction process.

Furthermore, according to the present embodiment, not only the intra prediction, but also processes such as orthogonal transform, quantization, inverse quantization, inverse orthogonal transform and the like may be parallelized. This enables to further increase the processing speed of the image encoding process and the image decoding process in the intra prediction mode.

Additionally, in the present specification, an example has been mainly described where the information about intra prediction and the information about inter prediction is multiplexed to the header of the encoded stream, and the encoded stream is transmitted from the encoding side to the decoding side. However, the method of transmitting this information is not limited to such an example. For example, this information may be transmitted or recorded as individual data that is associated with an encoded bit stream, without being multiplexed to the encoded bit stream. The term “associate” here means to enable an image included in a bit stream (or a part of an image, such as a slice or a block) and information corresponding to the image to link to each other at the time of decoding. That is, this information may be transmitted on a different transmission line from the image (or the bit stream). Or, this information may be recorded on a different recording medium (or in a different recording area on the same recording medium) from the image (or the bit stream). Furthermore, this information and the image (or the bit stream) may be associated with each other on the basis of arbitrary units such as a plurality of frames, one frame, a part of a frame or the like, for example.

Heretofore, a preferred embodiment of the present disclosure has been described in detail while referring to the appended drawings, but the technical scope of the present disclosure is not limited to such an example. It is apparent that a person having an ordinary skill in the art of the technology of the present disclosure may make various alterations or modifications within the scope of the technical ideas described in the claims, and these are, of course, understood to be within the technical scope of the present disclosure.

### Reference Signs List

10 Image encoding device (Image processing device)
14 Orthogonal transform section
41 Sorting section
42a First prediction section
42b Second prediction section
60 Image decoding device (Image processing device)
64 Inverse orthogonal transform section
91 Sorting section
92a First prediction section
92b Second prediction section

1-19. (canceled)

20. An image processing device comprising:
a grouping section for grouping a first pixel of a first sub-block included in a block in an image to be subjected to an intra prediction process and a second pixel of a second sub-block included in the block into a first group, and grouping a third pixel of the first sub-block and a fourth pixel of the second sub-block into a second group;
a sorting section for sorting pixel values included in the image such that the pixel values of the pixels of the respective groups grouped by the grouping section are in succession;
a first prediction section for generating predicted pixel values for the first group by performing an intra prediction process using the pixel values of the first group sorted by the sorting section;
a second prediction section for generating predicted pixel values for the second group by performing an intra prediction process using the pixel values of the second group sorted by the sorting section; and
a control section for executing the intra prediction process of the first prediction section and the intra prediction process of the second prediction process in parallel.

21. The image processing device according to claim 20, wherein
the grouping section further groups a first reference pixel adjacent to the first pixel and a second reference pixel adjacent to the second pixel into the first group, and groups a third reference pixel adjacent to the third pixel and a fourth reference pixel adjacent to the fourth pixel into the second group, and
the sorting section further sorts pixel values of the reference pixels included in the image such that the pixel values of the reference pixels of the respective groups grouped by the grouping section are in succession.

22. The image processing device according to claim 20, wherein a pixel position of the first pixel in the first sub-block and a pixel position of the second pixel in the second sub-block are at a same position, and a pixel position of the third pixel in the first sub-block and a pixel position of the fourth pixel in the second sub-block are at a same position.

23. The image processing device according to claim 22, wherein the first pixel, the second pixel, the third pixel and the fourth pixel are pixels belonging to a same line in the image.

24. The image processing device according to claim 20,
wherein the grouping section further groups a fifth pixel of the first sub-block and a sixth pixel of the second sub-block into the first group, and
wherein the first prediction section further generates predicted pixel values for the fifth pixel and the sixth pixel based on the predicted pixel values generated for the first pixel and the second pixel.

25. The image processing device according to claim 24, wherein the fifth pixel and the sixth pixel are pixels belonging to a different line from the first pixel and the second pixel in the image.

26. The image processing device according to claim 20, wherein, in a case a pixel on left of a processing target pixel is a pixel to be processed in parallel with the processing target pixel, the first prediction section or the second prediction section decides an estimated prediction mode for reducing a bit rate of prediction mode information, based on a prediction mode set for a sub-block above a sub-block to which the processing target pixel belongs.

27. The image processing device according to claim 20, wherein the first prediction section and the second prediction section perform generation of a predicted pixel value for each pixel in an intra 4×4 prediction mode.

28. The image processing device according to claim 20, further comprising
an orthogonal transform section for performing orthogonal transform for the first sub-block and orthogonal transform for the second sub-block in parallel.

29. The image processing device according to claim 20, wherein the grouping section dynamically selects the number of groups formed in the intra prediction process.

30. An image processing method for processing an image, comprising:
grouping a first pixel of a first sub-block included in a block in an image to be subjected to an intra prediction process and a second pixel of a second sub-block included in the block into a first group, and grouping a third pixel of the first sub-block and a fourth pixel of the second sub-block into a second group;
sorting pixel values included in the image such that the pixel values of the pixels of the respective groups obtained by the grouping are in succession;
generating predicted pixel values for the first group by performing an intra prediction process using the pixel values of the first group obtained by the sorting;
generating predicted pixel values for the second group by performing an intra prediction process using the pixel values of the second group obtained by the sorting; and
executing the intra prediction process for the first group and the intra prediction process for the second group in parallel.

31. An image processing device comprising:
a grouping section for grouping a first reference pixel adjacent to a first pixel of a first sub-block included in a block in an image to be subjected to an intra prediction process and a second reference pixel adjacent to a second pixel of a second sub-block included in the block into a first group, and grouping a third reference pixel adjacent to a third pixel of the first sub-block and a fourth reference pixel adjacent to a fourth pixel of the second sub-block into a second group;
a sorting section for sorting pixel values of the reference pixels included in the image such that the pixel values of the reference pixels grouped by the grouping section are in succession;
a first prediction section for generating predicted pixel values for the first group by performing an intra prediction process using the pixel values of the reference pixels of the first group sorted by the sorting section;
a second prediction section for generating predicted pixel values for the second group by performing an intra prediction process using the pixel values of the reference pixels of the second group sorted by the sorting section; and
a control section for executing the intra prediction process of the first prediction section and the intra prediction process of the second prediction process in parallel.

32. The image processing device according to claim 31, wherein a pixel position of the first pixel in the first sub-block and a pixel position of the second pixel in the second sub-block are at a same position, and a pixel position of the third pixel in the first sub-block and a pixel position of the fourth pixel in the second sub-block are at a same position.

33. The image processing device according to claim 32, wherein the first pixel, the second pixel, the third pixel and the fourth pixel are pixels belonging to a same line in the image.

34. The image processing device according to claim 31,
wherein the grouping section further groups a fifth pixel of the first sub-block and a sixth pixel of the second sub-block into the first group, and
wherein the first prediction section further generates predicted pixel values for the fifth pixel and the sixth pixel based on the predicted pixel values generated for the first pixel and the second pixel.

35. The image processing device according to claim 34, wherein the fifth pixel and the sixth pixel are pixels belonging to a different line from the first pixel and the second pixel in the image.

36. The image processing device according to claim 31, wherein, in a case a pixel on left of a processing target pixel is a pixel to be processed in parallel with the processing target pixel, the first prediction section or the second prediction section decides an estimated prediction mode for reducing a bit rate of prediction mode information, based on a prediction mode set for a sub-block above a sub-block to which the processing target pixel belongs.

37. The image processing device according to claim 31, wherein the first prediction section and the second prediction section perform generation of a predicted pixel value for each pixel in an intra 4×4 prediction mode.

38. The image processing device according to claim 31, further comprising
an inverse orthogonal transform section for performing inverse orthogonal transform for the first sub-block and inverse orthogonal transform for the second sub-block in parallel.

39. The image processing device according to claim 31, wherein the grouping section dynamically selects the number of groups formed in the intra prediction process.

40. An image processing method for processing an image, comprising:
grouping a first reference pixel adjacent to a first pixel of a first sub-block included in a block in an image to be subjected to an intra prediction process and a second reference pixel adjacent to a second pixel of a second sub-block included in the block into a first group, and grouping a third reference pixel adjacent to a third pixel of the first sub-block and a fourth reference pixel adjacent to a fourth pixel of the second sub-block into a second group;
sorting pixel values of the reference pixels included in the image such that the pixel values of the reference pixels obtained by the grouping are in succession;
generating predicted pixel values for the first group by performing an intra prediction process using the pixel values the reference pixels of the first group obtained by the sorting;
generating predicted pixel values for the second group by performing an intra prediction process using the pixel values of the reference pixels of the second group obtained by the sorting; and
executing the intra prediction process for the first group and the intra prediction process for the second group in parallel.
